(19) United States
(12) Patent Application Publication
(10) Pub. No.: US 2025/0135435 A1
(43) Pub. Date: May 1, 2025

(54) SYSTEM FOR BATCH SCALE PRODUCTION OF EXTRACTION SORBENTS WITH 3D PRINTING AND ASSOCIATED METHOD OF USE

(71) Applicant: Iowa State University Research Foundation, Inc., Ames, IA (US)

(72) Inventors: Jared L. Anderson, Ames, IA (US); Shu-An Hsieh, Ames, IA (US); Danial Shamsaei, Ames, IA (US)

(21) Appl. No.: 18/925,602

(22) Filed: Oct. 24, 2024

Related U.S. Application Data
(60) Provisional application No. 63/592,652, filed on Oct. 24, 2023.

(51) Int. Cl. B01J 20/26; B01J 20/28; B29C 33/56; B29C 64/129; B29C 64/386; B29C 64/40; B29K 33/00; B29K 79/00; B29L 31/00; B33Y 10/00; B33Y 70/00; B33Y 80/00; G01N 1/40

(52) U.S. Cl. CPC B01J 20/261; B01J 20/28004; B01J 20/28023; B29C 33/56; B29C 64/129; B29C 64/386; B29C 64/40; B33Y 10/00; B33Y 70/00; B33Y 80/00; G01N 1/405; B01J 2220/4812; B01J 2220/82; B29K 2033/08; B29K 2079/00; B29L 2031/731

(57) ABSTRACT

A system and method for 3D printed polymeric ionic liquid (PIL) extraction sorbents that includes a photocuring 3D printer utilizing a buildplate having a plurality of holes and a resin tank formed of a plurality of individual wells with a prepolymer monomer blended with a crosslinker and a photoinitiator is placed in the plurality of wells to form a plurality of 3D printed PIL sorbents on the buildplate, a fabrication device that prepares the polymeric ionic liquid (PIL) for extraction, at least one container for conditioning, extracting, and desorption of the polymeric ionic liquid (PIL); and a high-performance liquid chromatography (HPLC) to provide separation resulting in batch production of PIL sorbents. A polymeric ionic liquid (PIL) sorbent printed by 3D printer includes at least one PIL sorbent and can be in the form of a blade or fiber that has a high level of consistency.

### CROSS-REFERENCE TO RELATED APPLICATION

This application claims priority under 35 U.S.C. § 119 to Provisional Application U.S. Ser. No. 63/592,652, filed on Oct. 24, 2023, which is herein incorporated by reference in its entirety including without limitation, the specification, claims, and abstract, as well as any figures, tables, or examples thereof.

### STATEMENT REGARDING FEDERALLY SPONSORED RESEARCH OR DEVELOPMENT

This invention was made with government support under Grant Number CHE-2203891, awarded by the National Science Foundation and under Contract Number DE-AC02-07CH11358, awarded by the U.S. Department of Energy. The government has certain rights in the invention.

### TECHNICAL FIELD

The present disclosure relates generally to a system and method for 3D printed polymeric ionic liquid (PIL) extraction sorbents.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Sample preparation is an important step in chemical analysis, particularly in detecting analytes at trace levels, since minimizing or eliminating matrix interferences can increase sensitivity. Numerous miniaturized extraction techniques, including, but not limited to dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and dispersive solid phase extraction(d-SPE), have been developed to preconcentrate target analytes from complex samples. Among these, SPME is often employed for extracting volatile, semi-volatile, and non-volatile analytes from sample matrixes and has been widely applied in environmental monitoring, as well as in food and pharmaceutical analysis. The technique consists of a fiber support coated with a sorbent material that is exposed to the sample. After extraction, a thermal or solvent desorption process is performed by exposing the fiber to elevated temperatures or an organic solvent, respectively. Compared to other extraction techniques, SPME offers several advantages, including simplicity, low analyte detection limits, and versatility in the type of sorbent coating materials that can be tailored toward specific classes of analytes. To enhance selectivity, a number of materials have been employed as sorbent coatings, with polydimethylsiloxane (PDMS), polyacrylate (PA), and carboxen being among the most common.

In an effort to customize sorbent coatings for the extraction of target analytes, materials such as polymeric ionic liquids (PILs) have been explored. These are a class of compounds composed of ions with a melting point below 100° C. PILs, derived from the polymerization of ionic liquid (IL) monomers, are a class of functional materials that possess features of both polymers and ILs. They retain many advantages of ILs, such as low volatility, high thermal stability, and a broad range of chemical properties while exhibiting the structural rigidity of polymers. PIL-based sorbent coatings have been used in SPME and exhibit reproducible extraction efficiencies for a variety of analytes, ranging from nucleic acids to environmental pollutants in bottled drinking waters. Current fabrication processes for PIL-based SPME relies on manual coating techniques in which a thin layer of monomer, crosslinker, and photoinitiator mixture is applied to a support, such as nitinol or glass, followed by UV-assisted polymerization. However, high-throughput fabrication of PIL-coated fibers possessing highly reproducible fiber-to-fiber extraction efficiencies remains a significant obstacle. This challenge primarily arises from difficulties in coating large numbers of SPME fibers in a manner where the thickness of the coated layer is highly reproducible and customizable. Applications include DNA extractions and polycyclic aromatic hydrocarbons (PAHs) extraction from wastewater. The ratio of the crosslinker and the monomer depends on each other, where viscosity must be a controlling factor and should be kept below an unacceptable level.

Three-dimensional (3D) printing, also known as additive manufacturing, has grown significantly in a number of fields due to its advantages of rapid prototyping, while also being cost-effective, and easy to use. The costs of 3D printers have become more affordable in recent years, allowing them to expand to a number of areas within scientific and industrial research, such as dentistry, architecture building, food science, drug delivery, and analytical chemistry. However, developing novel printable materials has been hindered by the requirement of large volumes of prepolymer materials for commercial 3D printers, resulting in high costs. Furthermore, unsuccessful or undesirable polymerization of the tested prepolymer mixture can lead to significant waste due to the large volume requirements, which are often in the hundreds of milliliters. This underscores the need to develop simple and low-cost platform modifications for use in commercial 3D printers to accelerate the production of 3D printed materials, particularly for separation media used in chemical separations and sample preparation.

Previous investigations of 3D printed extraction devices have employed commercially available 3D filaments or resins. This includes a demonstration of a 3D-printed scabbard-like sorbent utilizing commercial thermoplastic materials by fused deposition modeling (FDM) for the analysis of steroids in human plasma. In addition, a prior study developed a 3D-printed preconcentrator using a commercial UV curable resin for the extraction of trace elements from seawater. Other studies developed printable PIL materials using costly inkjet 3D printers or custom-built printers to test the printability of materials. In addition, another prior study demonstrated the possibility of printing polymeric films with vinylimidazolium-based PILs. Although a commercial inkjet printer was used, considerable variation in the mechanical, thermal, and surface properties of the printed PIL films showcased the potential of 3D printed PILs for a range of applications.

Moreover, a prior study has demonstrated crosslinked phosphonium IL-based materials exhibiting high thermal stability, optical clarity, ion conductivity, and tunable glass transition temperatures using 3D-printed mask projection microstereolithography. However, the printing process required a complex custom printing platform that incorporates a light-emitting diode and several conditioning optics. A method involving simple modifications to a commercial 3D printer for the printing of photocurable sorbents at batch scales has yet to be achieved and is greatly needed to integrate 3D printing technologies more into the mainstream of sample preparation and chemical analysis.

Thus, there exists a need in the art for a system that reduces the printing volume of prepolymer mixtures from several hundreds of milliliters to just a few milliliters. There is also a significant need for a miniaturized printing platform that can be used to develop novel photocurable printing materials without requiring large amounts of testing material.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

A feature of this disclosure is a modification to a commercial resin 3D printer that significantly reduces the amount of prepolymer material needed for the production of polymeric ionic liquid (PIL) extraction sorbents. The modified printing platform requires microliter volumes of prepolymer mixture and is demonstrated in the printing of two imidazolium-based ionic liquid (IL) monomers. Although other geometries are feasible, two geometries resembling a blade-type PIL sorbent used in thin-film microextraction (TFME), and a fiber-type sorbent used in solid-phase microextraction (SPME) were examined. The fiber PIL sorbents were used to extract ten organic contaminants, including plasticizers, antimicrobial agents, UV filters, and pesticides, from water analysis followed by high-performance liquid chromatographic analysis. To compare the extraction performance of the SPME sorbents, seven fibers printed with the same prepolymer composition from the same printing batch, as well as different batches, were evaluated. It was found that the relative standard deviation (% RSD) of the peak areas for all analytes using all tested sorbents were lower than 20%. Additionally, no statistical difference in the extraction performance of the sorbents was found using principal component analysis, indicating the exceptional potential of 3D printing in the fabrication of PIL sorbents producing highly reproducible extraction performance. Method validation showed acceptable linearity (R²>0.92) for all analytes with detection limits and quantification limits ranging from 0.13 to 45 μg L⁻¹ and 0.43 to 150 μg L⁻¹, respectively.

Another feature of this invention is a simple, low-cost modification to a commercial desktop light crystal display (LCD) 3D printer that enables the printing of PIL materials using prepolymer mixture volumes ranging from a hundred microliters to tens of milliliters. Prepolymer mixtures consisting of prepolymer monomers were blended with the crosslinker diurethane dimethacrylate (DUDMA) and diphenyl(2,4,6-trimethylbenzoyl) phosphine oxide (TPO) as photoinitiator to fabricate PIL sorbents. This modification was demonstrated in the simultaneous printing of ten blade-type PIL sorbents used in TFME, and twelve fiber-type sorbents used in SPME. The SPME sorbents were used to extract a variety of emerging and persistent contaminants from water under optimal conditions, followed by HPLC analysis. Analyte extraction efficiencies obtained from printed SPME sorbents were compared to those printed from the same batch as well as to those printed in different batches. The lifetimes of the printed sorbents provide a significant advantage.

It is a further object, feature, and/or advantage of the present disclosure is a system for 3D printed extraction of polymeric ionic liquid (PIL) sorbents that includes a photocuring 3D printer utilizing a build plate having a plurality of holes and a resin tank formed of a plurality of individual wells with a prepolymer monomer blended with a crosslinker and a photoinitiator is placed in the plurality of wells to form a plurality of 3D printed PIL sorbents on the build plate, fabrication device that prepares the polymeric ionic liquid (PIL) for extraction, at least one container for conditioning, extracting, and desorption of the polymeric ionic liquid (PIL), and a high-performance liquid chromatography (HPLC) to provide separation resulting in a batch production of PIL sorbents.

A further object, feature, and/or advantage of the present disclosure is a build plate having a plurality of holes and the resin tank formed of a plurality of individual wells created by a 3D printer.

Still another aspect of the present disclosure is a resin tank formed of a plurality of individual wells are each coated with an elastomer.

Another aspect of the present disclosure is an extraction device that includes a projectile and an adhesive.

Yet another aspect of the present disclosure is a 3D-printed sorbent that is in the form of either a blade sorbent or fiber sorbent.

Another feature of the present disclosure is a container that includes either ACN or MeOH for at least partial immersion and conditioning of either the blade sorbent or the fiber sorbent.

Yet another aspect of the present disclosure is at least one prepolymer monomer combined with a crosslinker and a photoinitiator, and is either in the form of a blade or a fiber that has a high level of thickness consistency without being dipped.

Still, yet another feature of the present disclosure is a polymeric ionic liquid (PIL) sorbent prepolymer monomer that is selected from the group consisting of [OVIM][Br] or [OVIM][NTf₂], the crosslinker includes DUDMA and the photoinitiator includes TPO and is either in the form of a blade or a fiber that has a high level of thickness consistency without being dipped.

Another feature of the present disclosure is a blade that has dimensions in the range from about 0.1 millimeters to about 1 meter in length, from about 0.5 millimeters to about 1 meter in width, and from about 0.1 millimeters to about 1 meter in height.

Still another aspect of the present disclosure is a fiber that has dimensions in the range from about 0.6 millimeters to about 1 meter in diameter and from about 0.1 millimeters to about 1 meter in length.

A further feature of the disclosure is at least one prepolymer mixture that includes a prepolymer monomer combined with a crosslinker and a photoinitiator that has a high level of consistency without being dipped.

Still, another feature of the present disclosure is a plurality of PIL sorbents that include a combination of blades and fibers.

Still yet another feature of the present disclosure is a method of creating 3D printed polymeric ionic liquid (PIL) extraction sorbents that includes placing at least one prepolymer monomer with a crosslinker and a photoinitiator (to polymerize and form a PIL sorbent) into a customized resin tank formed of a plurality of individual wells, utilizing a photocuring 3D printer having a build plate with a plurality of holes and the customized resin tank formed of a plurality of individual wells, and printing PIL sorbents in the form of a rectangular blade or a cylindrical fiber.

Another aspect of the present disclosure is at least one prepolymer monomer that is selected from the group consisting of [OVIM][Br], or [OVIM][NTf₂], the crosslinker includes DUDMA and the photoinitiator includes TPO.

An additional feature of the disclosure is a step of removing uncured residual resin after the printing of the PIL sorbents.

Yet another feature of the method of the present disclosure is a step of post-curing through applying UV light to the PIL sorbents after removing uncured residual resin after the printing of the PIL sorbents.

Another aspect of the present disclosure is a step of extracting the printed PIL sorbents.

It is still yet another feature of the method of the present disclosure, which is a step of conditioning the printed PIL extraction sorbents.

It still another feature of the method of the present disclosure is a step of conditioned the polymeric ionic liquid (PIL) followed by a step of desorbing the extracted analytes from the polymeric ionic liquid (PIL).

It is yet another feature of the method of the present disclosure, which is a step of utilizing an analytical instrument to provide separation resulting in batch production of PIL sorbents.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE FIGURES

The patent or application file contains at least one drawing or photograph executed in color. Copies of this patent or patent application publication with color drawing(s) will be provided by the Office upon request and payment of the necessary fee.

The following drawings form part of the specification and are included to further demonstrate certain embodiments. In some instances, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments. Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a side schematic view of a 3D (additive) printing operation associated with the disclosed invention.

FIG. 2 is a bottom view of a commercial resin tank and a bottom view of a commercial build plate for a standard LCD 3D printer.

FIG. 3 is a bottom view of a customized six-hole build plate for a standard LCD 3D printer.

FIG. 4 is a top view of a customized six-hole build plate for a standard LCD 3D printer shown in FIG. 3.

FIG. 5 is a bottom view of a customized six-well resin tank for a standard LCD 3D printer.

FIG. 6 is a bottom view of a customized twenty-four-hole build plate for a standard LCD 3D printer.

FIG. 7 is a top view of a customized twenty-four hole build plate for a standard LCD 3D printer shown in FIG. 6.

FIG. 8 is a bottom view of a customized twenty-four well resin tank for a standard LCD 3D.

FIG. 9 is a schematic of the setup for a 6-hole build plate and a 24-hole build plate when printing with an FDM 3D printer.

FIG. 10 is a schematic of a model file to set up parameters for printing with an LCD 3D printer using black polylactic acid filament.

FIG. 11 is a side view of an assembly of one of the twenty-four-hole build plates that includes one screw, two hex nuts, and five round disc magnets.

FIG. 12 is a side view of an assembly of the six-hole build plate using two screws and a flat head nut.

FIG. 13 is a ¹H NMR spectrum of [OVIM][Br] IL. ¹H NMR (400 MHZ, chloroform-d): δ (ppm) 0.87-0.90 (t, 3H), 1.22-1.42 (m, 10H), 1.93-2.01 (m, 2H), 4.41-4.44 (m, 2H), 5.97-6.02 (d, ¹H), 7.48-7.55 (m, 2H), 7.78 (s, ¹H), 11.11 (s, ¹H).

FIG. 14 is a ¹C NMR spectrum of [OVIM][Br] IL. ¹³C NMR (400 MHZ, chloroform-d): δ (ppm) 13.88, 22.36, 26.01, 28.75, 28.81, 30.07, 31.46, 50.22, 109.61,119.73, 122.93, 128.15, 135.70.

FIG. 15 is a ¹H NMR spectrum of [OVIM][NTf₂] IL. ¹H NMR (400 MHZ, chloroform-d): δ (ppm) 0.87-0.90 (t, 3H), 1.22-1.42 (m, 10H), 1.93-2.01 (m, 2H), 4.41-4.44 (m, 2H), 5.97-6.02 (d, ¹H), 7.48-7.55 (m, 2H), 7.78 (s, ¹H), 11.11 (s, ¹H).

FIG. 16 is a ¹C NMR spectrum of [OVIM][NTf₂] IL. ¹³C NMR (400 MHZ, chloroform-d): d (ppm) 13.97, 22.52, 26.04, 28.76, 28.89, 29.93, 31.58, 50.63, 110.41, 117.95, 119.30, 121.13, 122.99, 127.90, 134.19.

FIG. 17 is a schematic of the digital model and printing setup for 3D printed blade and fiber PIL sorbents with ten cuboids (representing blade-type sorbent) created using software.

FIG. 18 is a schematic of the digital model and printing setup for a 3D printed blade and fiber PIL sorbents of the cuboids of FIG. 17 with the digital files were sent to the software to set up the printing parameters for printing with an LCD 3D printer.

FIG. 19 is a schematic of the digital model and printing setup for 3D printed blade and fiber PIL sorbents with twelve cylinders (representing fiber-type sorbent) created using software.

FIG. 20 is a schematic of the digital model and printing setup for a 3D printed blade and fiber PIL sorbents of the twelve cylinders of FIG. 19 with the digital files were sent to the software to set up the printing parameters for printing with an LCD 3D printer.

FIGS. 21A-21C are scanning electron micrographs (SEM) showing the 3D printed blade and fiber PIL sorbents consisting of 85% (w/w) [OVIM][Br] IL, 12% (w/w) DUDMA, and 3% (w/w) TPO (FIG. 21A and FIG. 21B) and a fiber sorbent consisting of 85% (w/w) [OVIM][NTf₂] IL, 12% (w/w) DUDMA, and 3% (w/w) TPO (FIG. 21C).

FIG. 22 is a side view of an assembly of an extraction device with 3D printed PIL sorbent that includes a prepared 3D printed PIL sorbent, epoxy glue, and a blunt tip syringe needle.

FIGS. 23A-23D are side views of an examination of organic solvent compatibility with 3D printed blade and fiber PIL sorbents with one of the 3D printed blades placed in ACN (FIG. 23A) and, another blade placed in MeOH (FIG. 23B) and a 3D printed fiber sorbent was placed in can (FIG. 23C), and another fiber sorbent was placed in MeOH (FIG. 23D).

FIG. 24 are overlaid chromatograms obtained at 220 nm (blue), 254 nm (green), and 305 nm (red) after direct injection of analytes where separations were performed with a column using an HPLC-DAD system.

FIG. 25 is a side view of PIL printability test with the miniaturized printing platform using a commercial desktop LCD 3D printer utilizing a blade printed with a dimension of 15 millimeters (L)×2.5 millimeters (W)×0.5 millimeters (H) using approximately 1 milliliter of prepolymer mixture consisting of 50% (w/w) of [OVIM][Br] IL, 47% (w/w) DUDMA, and 3% (w/w) TPO.

FIG. 26 is a side view of PIL printability test with the miniaturized printing platform using a commercial desktop LCD 3D printer utilizing simultaneous printing with different prepolymer mixtures with compositions of 50% (w/w) of [OVIM][Br], 47% (w/w) DUDMA, and 3% (w/w) TPO and 85% (w/w) of [OVIM][Br], 12% (w/w) DUDMA, and 3% (w/w) TPO.

FIG. 27 is a side view of a PIL printability test with the miniaturized printing platform using a commercial desktop LCD 3D printer utilizing batch printing of PIL sorbents featuring two different form factors. A total of ten blades and twelve fiber PIL sorbents were printed simultaneously. The fiber PIL sorbents were printed with a circular diameter of 600 micrometers and a length of 12 millimeters.

FIG. 28 is a schematic showing the procedures used in creating 3D printed PIL sorbents with 3D printing of PIL sorbents using a modified LCD 3D printer, assembly of the extraction devices with a projectile (the projectile can be a syringe needle, a hollow metal tube, or a non-hollow cylinder), epoxy glue, and the prepared 3D printed sorbent, conditioning of the sorbent in organic solvent, extraction and desorption of analytes, and separation and detection of analytes using HPLC-DAD.

FIGS. 29A-29C are graphs of a comparison of extraction efficiencies for 3D printed fibers with fibers PIL 2a, PIL 2b, and PIL 2c (FIG. 29A) were obtained from the same printing well and printed at the same time, fibers PIL 2a, PIL 2d, and PIL 2e (FIG. 29B) were obtained from different printing wells and printed at the same time; and fibers PIL 2a, PIL 2f, and PIL 2g (FIG. 29C) were obtained from different printing wells and printed at different times.

FIGS. 30A-30C are graphs of a comparison of sorbent-to-sorbent extraction data using principal component analysis (PCA) of ten analytes extracted by 3D-printed fiber sorbents.

FIGS. 31A-31B shows sorption-time profiles obtained using the PIL 2d sorbent in color to illustrate the different sorption profiles. The ten analytes include bisphenol A (dark blue trendline), oxybenzone (red trendline), triclocarban (tan trendline), chlorfenapyr (yellow trendline), flufenoxuron (light blue), hexythiazox (light green), octocrylene (dark blue), padimate-O (brown), 2-ethylhexyl salicylate (dark green), and homosalate (purple). FIG. 31A is the full sorption-time profile and FIG. 31B is zoomed in to better differentiate the lines close together.

FIG. 32A is a schematic showing the 3D printed fibers used for extraction and chromatographic analysis.

FIG. 32B is a schematic showing the analytical workflow of the extraction process using the 3D printed fiber system and downstream thermal desorption into a gas chromatograph coupled to mass spectrometry (GC/MS). Extraction of analytes is facilitated by interactions that occur between analytes and the 3D printed fiber. Analytes are thermally desorbed from the 3D printed fiber in the SPME device by exposing the fiber system to the heated inlet of the GC/MS system.

FIG. 33A is a chromatogram showing the direct injection of standards. The chromatogram shows the results of the direct injection of 1 μL of a mixture containing eleven analytes (β-Pinene, γ-Terpinene, Mequinol, Linalool, Isoborneol, Menthol, Terpinen-4-ol, Geraniol, Thymol, Eugenol, and Nerolidol) at a concentration of 50 mg/L in methanol.

FIG. 33B is a chromatogram of fiber blank. The fiber blank was analyzed by exposing the fiber to the GC inlet for 2 minutes at 250° C.

FIG. 33C is a chromatogram of the first desorption following an extraction. Displayed in the chromatogram is the first desorption following headspace extraction of the eleven analytes (spiked at 5 mg/L) using the 3D printed PIL SPME fiber.

FIG. 33D is an overlay of the chromatograms of a direct injection and a first desorption after headspace extraction following an extraction.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

So that the present disclosure may be more readily understood, certain terms are first defined. Unless defined otherwise, all technical and scientific terms used herein have the same meaning as commonly understood by one of ordinary skill in the art to which embodiments of the disclosed and methods pertain.

### Definitions

It is to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various embodiments of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The term “about,” as used herein, refers to variations in size, distance, concentration, temperature, wavelength, pKa, or any other types of measurements that can be resulted from the inherent heterogeneous nature of the measured objects and imprecise nature of the measurements themselves. The term “about” also encompasses variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods, and the like. The term “about” also encompasses amounts that differ due to different equilibrium conditions for a composition resulting from a particular initial mixture. Whether or not modified by the term “about”, the claims include equivalents to the quantities.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having 2 to about 30 carbon atoms, and further including at least one double bond. In some embodiments, alkenyl groups have from 2 to about 20 carbon, or typically, from 2 to 10 carbon atoms. Alkenyl groups may be substituted or unsubstituted. Alkenyl groups may be substituted similarly to alkyl groups.

As used herein, the terms “alkylene”, cycloalkylene “, alkynylene, and alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

As used herein, “aryl” or “aromatic” groups are cyclic aromatic hydrocarbons that do not contain heteroatoms. Aryl groups include monocyclic, bicyclic, and polycyclic ring systems. Thus, aryl groups include, but are not limited to, phenyl, azulenyl, heptalenyl, biphenylenyl, indacenyl, florenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, in others from 6 to 12 or 6-10 carbon atoms in the ring portions of the groups. The phrase “aryl groups” includes groups containing fused rings, such as fused aromatic-aliphatic ring systems. Aryl groups may be substituted or unsubstituted.

As used herein, the term “exemplary” refers to an example, an instance, or an illustration, and does not indicate a most preferred embodiment unless otherwise stated.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims.

The PIL sorbents can be useful for a variety of analyte extraction techniques including, but not limited to dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and dispersive solid phase extraction (d-SPE).

Embodiments of the disclosed methods are further defined in non-limiting Examples provided as part of the following disclosure. The Examples, while indicating certain embodiments of the disclosed methods, are given by way of illustration only and should not be considered as limiting in any way. From the above discussion and these Examples, one skilled in the art can ascertain the essential characteristics of this disclosure, and without departing from the spirit and scope thereof, can make various changes and modifications of the embodiments of the disclosed methods to adapt it to various usages and conditions. Thus, various modifications of the embodiments of the disclosed methods, in addition to those shown and described herein, will be apparent to those skilled in the art from the foregoing description. Such modifications are also intended to fall within the scope of the appended claims.

### 3D Printed PIL Sorbents

A feature of this disclosure is a modification to a commercial resin 3D printer provides for the printing of PIL extraction sorbents. As disclosed herein, a printing system can be provided that prints at low volumes and manufactures blades, fibers, or other sorbents with appropriate dimensions for TFME, SPME and other extraction techniques. Although other geometries are feasible, two geometries resembling a blade-type extraction sorbent used in thin-film microextraction (TFME), and a fiber-type extraction sorbent used in solid-phase microextraction (SPME) were examined. The systems and methods comprise obtaining a prepolymer and combining that with a crosslinker and a photoinitiator. The term “photoinitiator” encompasses all possible photoinitiator relevant to 3D printing, including but not limited to Type I photoinitiators which decompose upon exposure to light, generating free radicals directly and Type II photoinitiators which require a co-initiator or sensitizer to produce free radicals upon light exposure, typically through a hydrogen transfer reaction. Some preferred photoinitiators are described herein however many other photoinitiators could be utilized than the species utilized in the examples herein.

### Extraction Techniques and Device

The PIL sorbents can be utilized in a number of extraction techniques and devices. For example, extraction techniques and devices which can include the eutectic sorbents disclosed herein include, but not limited to dispersive liquid-liquid extraction (DLLME), solid-phase microextraction (SPME), stir bar sorptive microextraction (SBSE), thin-film microextraction (TFME), vortex-assisted solid-phase microextraction (VA-DSPME), capsule-phase microextraction (CPME), and dispersive solid phase extraction (d-SPE).

An extraction device should include a projectile, an adhesive, and the PIL sorbent. The printed PIL sorbent can be in the form of a blade or a cylindrical fiber. Beneficially, the printed sorbent can have consistent thickness without being dipped. If printed as a blade, the blade preferably has a length of from about 0.1 millimeters to about 1 meter in length, more preferably 0.1 mm to about 0.5 meters, most preferably 0.1 mm to about 10 mm; a width of from about 0.5 millimeters to about 1 meter, more preferably 0.1 mm to about 0.5 meters, most preferably 0.1 mm to about 10 mm; and from about 0.1 millimeters to about 1 meter in height; and any integer or decimal in the foregoing ranges. If printed as a cylindrical fiber, the fiber preferably has a diameter of from about 0.6 millimeters to about 1 meter in diameter and length of from about 0.1 millimeters to about 1 meter; and any integer or decimal in the foregoing ranges.

The PIL sorbents can be used for any suitable extraction technique, which would typically include the steps of contacting the PIL extraction sorbent with a sample, wherein the sample comprises an analyte; and wherein the analyte is a solid and is adsorbed, or a liquid and is absorbed. In a preferred embodiment, the method further comprising a step of desorbing the analyte from the PIL extraction sorbent. In a preferred embodiment, the method further comprises testing the analyte with an analytical instrument. In a preferred embodiment, the testing comprises quantifying the analyte and/or identifying qualitatively identifying the analyte.

Suitable analytical instrument include but are not limited to a high performance liquid chromatography instrument (“HPLC”), an ultra-performance liquid chromatography instrument (“UPLC”), a next generation chromatograph (“NGC”), a mass spectrometer (“MS”), a gas chromatograph (“GC”), a colorimeter, a fluorometer, a photometer, a spectrometer, a spectrophotometer, a X-ray photoelectron spectrometer (“XPS”), or a combination thereof. If multiple instruments are included, they are preferably arranged sequentially and not in parallel; however, in some configurations parallel arrangement can be provided.

### 3D Printing System.

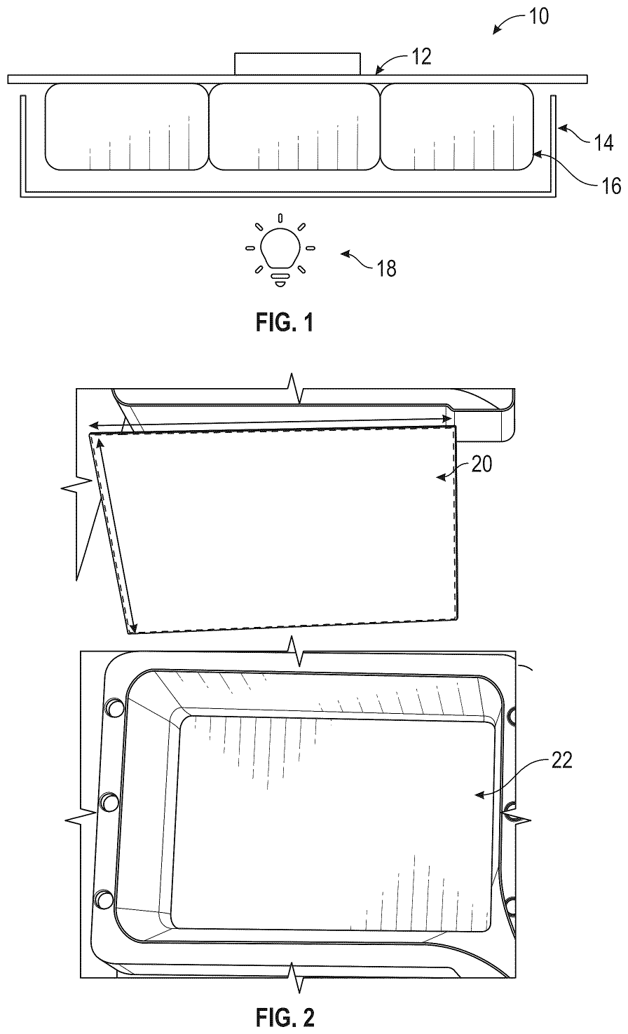

A central component of this system is a 3D or additive manufacturing printer that provides a method of creating three-dimensional objects layer-by-layer utilizing computer modeling design. Preferably, this includes a liquid crystal diode 3D printer. Referring now to FIG. 1, the main components of a 3D printer are generally indicated by the numeral 10. This includes a build plate 12 and a material tank 14 that holds the 3D printing material 16, such as prepolymers, e.g., a mixture of monomer, crosslinker, photoinitiator, and so forth. There is also a light source 18, e.g., liquid crystal diode. Illustrative, but nonlimiting examples, of 3D printers that can be utilized include SLA, SLA-LCD, and SLA-DLP type printers. Black polylactic acid (PLA) filament (2.85 millimeter diameter) was obtained from Dynamism Inc. in Chicago, Illinois; the black PLA was printed on an FDM printer to form the custom build plate used for the methods disclosed herein.

For comparison, FIG. 2 shows the commercial build plate 20 and a commercial material tank 22. The commercial build plate 20 features rectangular dimensions of 85 millimeters (length)×125 millimeters (width).

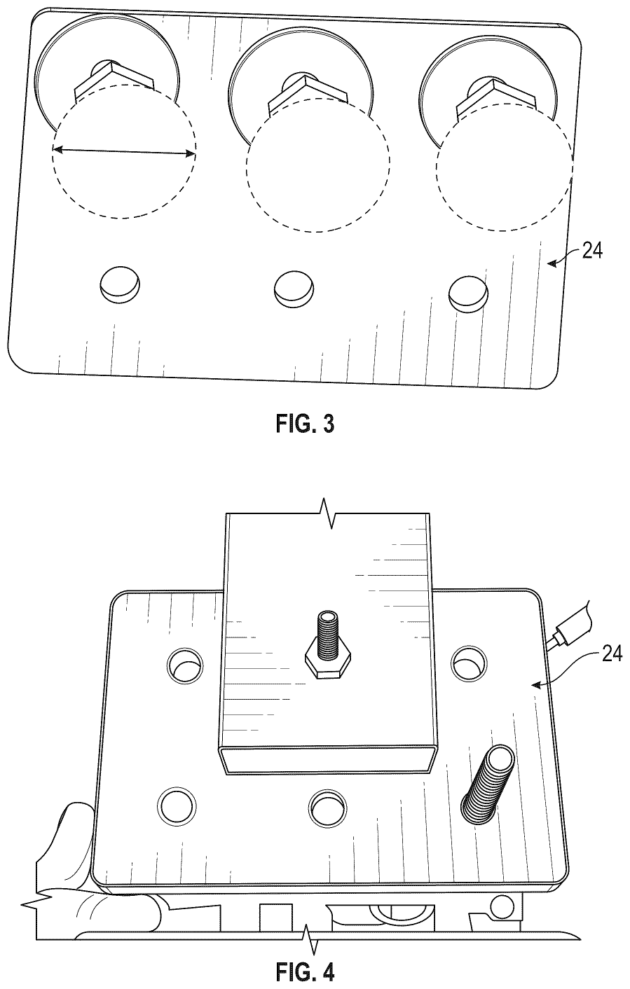

Miniaturization of the LCD 3D printe 10 includes modification to the build plate 12 and material, e.g., resin, tank 14. A six-hole customized build plate is indicated by the numeral 24 in FIG. 3. The top view of the six-hole customized build plate 24 is shown in FIG. 4. The six-hole build plate 24 has six circular holes having diameters of preferably, but not necessarily, 8.5 millimeters.

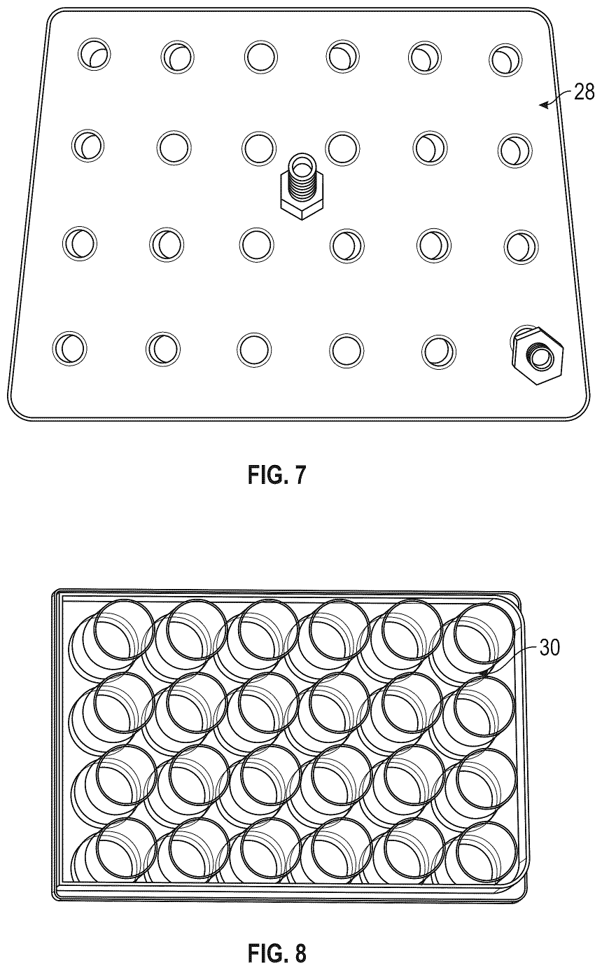

A twenty-four-hole customized build plate is indicated by the numeral 28 in FIG. 6. The top view of the six-hole customized build plate 28 is shown in FIG. 7. The twenty-four hole build plate 28 has twenty-four printing platforms with a circular shape and a diameter of preferably, but not necessarily, five millimeters.

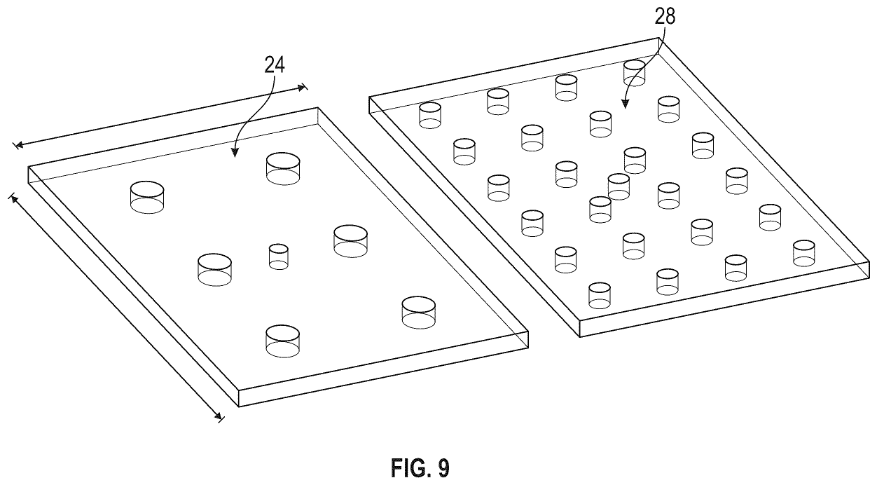

The software first modeled six-hole and twenty-four-hole customized build plates 24 and 28, respectively, shown in FIG. 9, to preferably have dimensions of 125 millimeters×85 millimeters×5 millimeters (L×W×H).

An illustrative, but nonlimiting example of this type of software includes Autodesk Inventor® software. Autodesk Inventor® is a federally registered trademark of Autodesk, Inc., having a place of business at The Landmark @ One Market 1 Market Street, Suite 400, San Francisco, California 9410 .

Both computer-aided design software files were transferred to a slicer to set up printing parameters and then to a printer. Nonlimiting, but illustrative examples include an Ultimaker® Cura slicer and an Ultimaker® S5 3D printer. Ultimaker® is a federally registered trademark of Ultimaker Holding BV, having a place of business at Watermolenweg 2, Geldermalsen, Netherlands 4191PL.

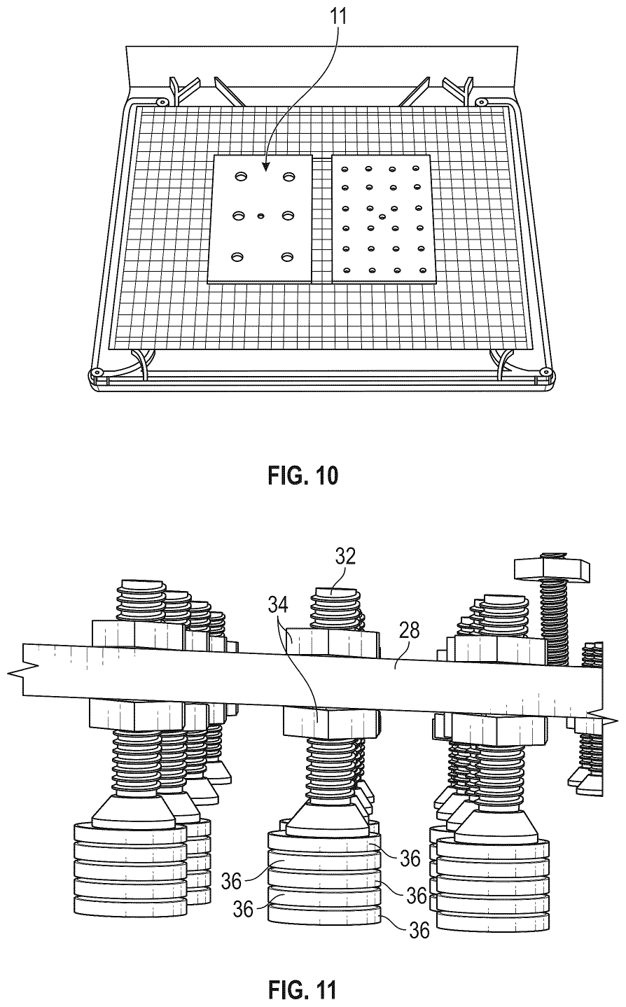

Printing occurs with black polylactic acid filament, as shown in FIG. 10 by numeral 11. The printing parameters are: a print speed of 100 millimeters/second; layer height of 0.15 millimeters; printing nozzle temperature of 200° C.; build plate 24, 28 temperature of 90° C.; and the nozzle type is an AA 0.4 nozzle.

Comparison of the three types of build plates 20, 24, and 28 are shown below in Table 1 below:

TABLE 1
Comparison of the three types of build plates 20, 24, and 28.

| | | 2 × 3 Build | 4 × 6 Build |
|---|---|---|---|
| | Commercial 20 | Plate 24 | Plate 28 |
| Number of materials | Only one | Up to six | Up to twenty- |
| can be printed | | | four |
| simultaneously | | | |
| Minimal material | about 10-100 mL | about 1-3 mL | about 0.5-1 mL |
| volume required | | | |
| Usage | Larger print | Slightly larger | For material |
| | | print | testing |

After printing was completed, the screws and nuts were utilized to secure build plates to the LCD 3D printer 10. For example, referring now to FIG. 11, assembly of one of the twenty-four hole build plates 28 can include, but not necessarily include, one 5/16″-18 screw 32, two hex nuts 34, and five round disc magnets 36.

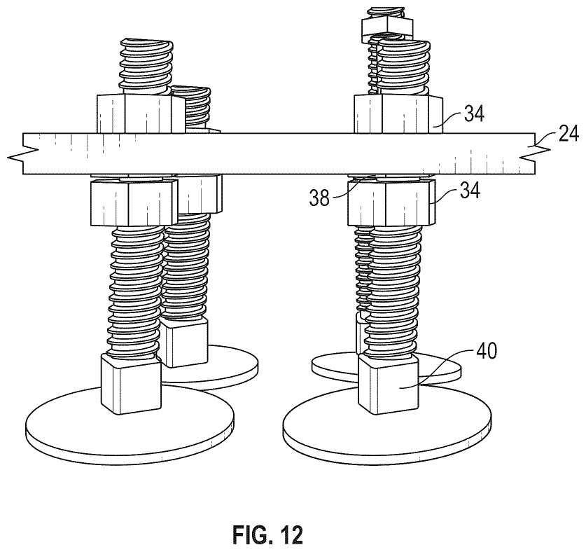

Referring now to FIG. 12, assembly of one of the six-hole build plates 24 can include, but not necessarily, one flat head screw 40, two hex nuts 34, and a locking washer 38.

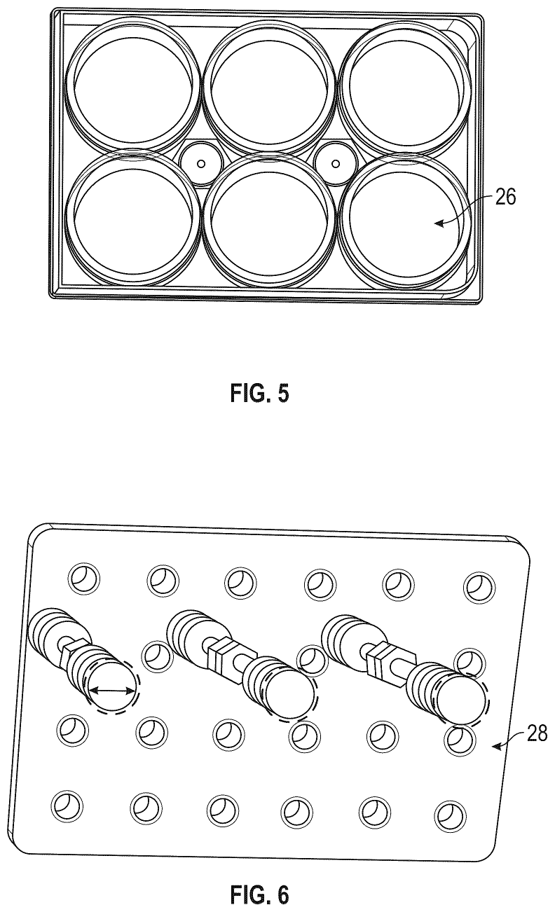

There is a twenty-four-well customized cell plate 30, which is shown in FIG. 8, and the six-well cell plate 26, which is shown in FIG. 5, that functions as miniaturized resin tanks and is preferably, but not necessarily, coated with PDMS. Polydimethylsiloxane (PDMS) is an elastomer with excellent optical, electrical, and mechanical properties. To coat a cell plate 30, 26, the Corning® cell culture plates were first cleaned thoroughly with a disposable wiping cloth made of soft, non-abrasive fibers that are designed to be gentle on delicate surfaces, e.g., Kimwipes®, using water and methanol to prevent dust from remaining on the plate. Corning® is a registered trademark of Corning Incorporated, having a place of business at One Riverfront Plaza, Corning, New York, and Kimwipes® is a federally registered trademark of the Kimberly-Clark Corporation, having a place of business at 401 North Lake Street, Neenah, Wisconsin 54956.

The PDMS elastomer was then poured into a small beaker at a volume ratio of ten milliliters to one milliliter of the curing reagent, followed by thorough manual mixing. The mixture was carefully poured into the wells until a thickness of approximately one millimeter was applied. The coated cell plates or resin tanks 30, 26 were left for twenty-four hours at room temperature before use.

The demand for large material volumes required for printing with commercial 3D printers presents a significant obstacle for researchers seeking to develop novel printable materials. By downsizing the volume of required starting materials, the prepolymer mixture can be more efficiently adapted for test printing while also significantly reducing costs and waste. To investigate the printability of PIL sorbents, a low-cost modification to a miniaturized commercial LCD printer was first performed. Two build plate platforms with dimensions of 125 millimeters (height) and 85 millimeters (width) were modeled with software, e.g., Autodesk Inventor® software, as shown in FIG. 9. A 6-hole design 24 and 24-hole design 28 on the build plate platforms were matched to the distribution of wells within commercial cell culture plates. FIG. 10 shows the build plate base 11 (three-millimeter thickness) fabricated by a 3D printer, e.g., fused deposition modeling (FDM) 3D printer, using polylactic acid (PLA), e.g., black PLA filament. A total of six and twenty screws and nuts were then assembled at each position of the holes on the build plate platform base, as shown in FIGS. 11 and 12. Four round disk magnets 36 with a circular diameter of twelve millimeters were applied to the screws 32 to form a flat surface on the build plate 28 for the twenty-four hole design.

Culture plates containing wells 30 were chosen to serve as miniaturized resin tanks because they are transparent and have a flat bottom, which permits ultraviolet (UV) light transmission. This configuration required only 800 to 1000 microliters of resin in each well to initiate a successful print, compared to commercial printing platforms that require more than 150 milliliters of resin to cover the entire resin tank. As provided in Table 1, minimal resin material is required in the methods disclosed herein.

To showcase the customizability of the modification method, a six-hole printing platform featuring six screws with a dimension of 30 millimeters was designed as a build plate 24 to print larger objects and compared to the 24-hole design 28, as shown in FIG. 9. Culture plates containing six wells were chosen to serve as the resin tank for this design, and a minimum volume of two, three, or four millimeters was required to initiate a print for this platform. Modifications that enable the use of different build plate sizes and material tank volumes demonstrate the versatility of this approach in customizing the desired printing requirements.

### EXAMPLE 1

### Synthesis of the [OVIM][Br] IL Monomer

The next step in the process is for the synthesis of the [OVIM][Br] IL monomer, which involved reacting 20 mmol of 1-vinylimidazole and 24 mmol of 1-bromooctane in a round bottom flask containing 10 milliliters of 2-propanol at 60° C. for thirty-six hours under a nitrogen atmosphere. The reaction mixture was cooled to room temperature, and 2-propanol was removed under vacuum. The crude product was dissolved in water, and purification was achieved by washing three times with ten-milliliter aliquots of ethyl acetate. Purified [OVIM][Br] IL was recovered by removing water under vacuum at 50° C., yielding the monomer as a viscous yellow liquid. A Varian® MR-400 MHz nuclear magnetic resonance (NMR) spectrometer was used to collect the ¹H NMR and ¹³C NMR spectra to characterize the purified final product. Varian® is a federally registered trademark of Varian Medical Systems Technologies, Inc., having a place of business at 3100 Hansen Way, Palo Alto, California 94304.

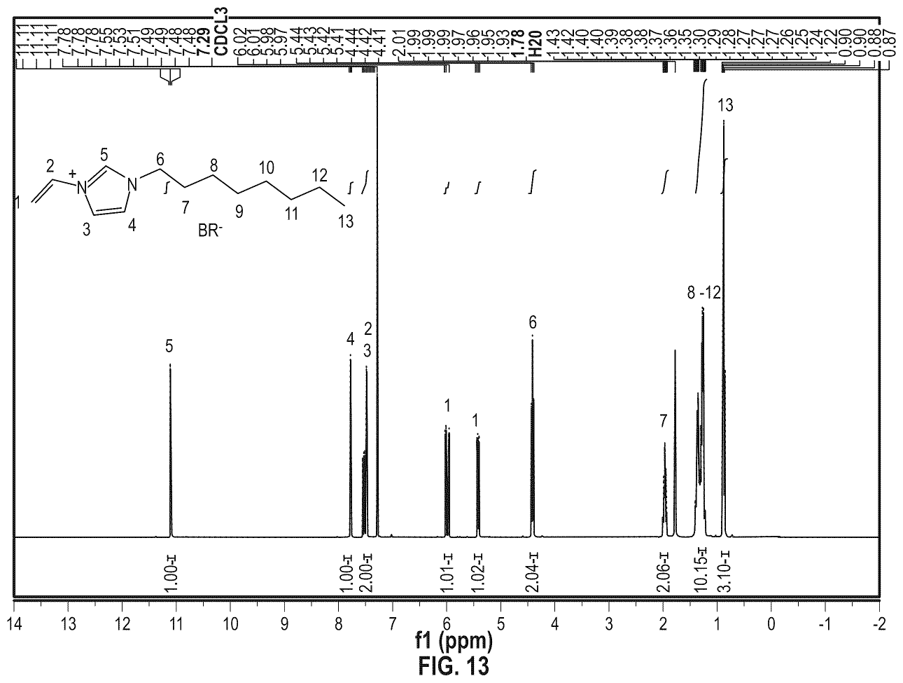

This is shown in FIG. 13, which is a ¹H NMR spectrum of [OVIM][Br] IL. ¹H NMR (400 MHZ, chloroform-d): δ (ppm) 0.87-0.90 (t, 3H), 1.22-1.42 (m, 10H), 1.93-2.01 (m, 2H), 4.41-4.44 (m, 2H), 5.97-6.02 (d, ¹H), 7.48-7.55 (m, 2H), 7.78 (s, ¹H), 11.11 (s, ¹H).

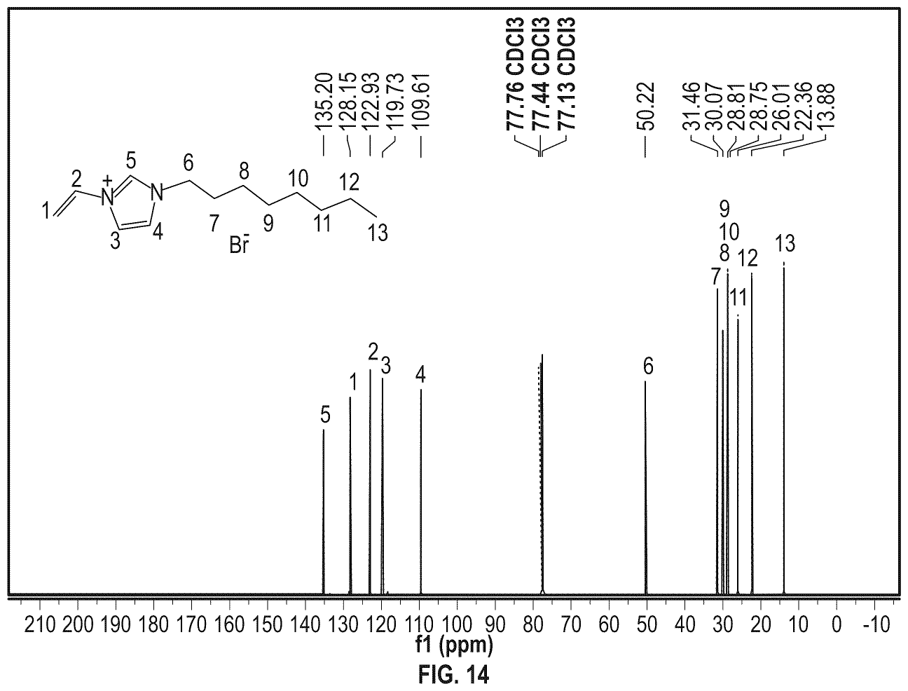

This is also shown in FIG. 14, which is a ¹C NMR spectrum of [OVIM][Br] IL. ¹³C NMR (400 MHZ, chloroform-d): δ (ppm) 13.88, 22.36, 26.01, 28.75, 28.81, 30.07, 31.46, 50.22, 109.61, 119.73, 122.93, 128.15, 135.70.

Water content was found to be less than 1% (w/w) using a Karl Fischer™M coulometric titrator from Brinkmann Instruments, Inc., doing business as Metrohm, having a place of business at 9250 Camden Field Parkway Riverview, Florida 33578.

### EXAMPLE 2

### Synthesis of the [OVIM][NTf₂] IL Monomer

Synthesis of the [OVIM][NTf₂] IL monomer involved a metathesis reaction consisting of 10 mmol of [OVIM][Br] and 13 mmol of LiNTf2 in a 250-milliliter round bottom flask. The reaction was stirred at room temperature for twenty-four hours. After decanting the upper water layer, a light-yellow oily IL monomer layer appeared at the reaction's bottom. The crude IL layer was then dissolved in dichloromethane and washed five times with twenty milliliters of water. The final aqueous layer was tested with silver nitrate to ensure no silver chloride precipitation was formed. The purified [OVIM][NTf₂] IL was then collected, and the solvent was removed under vacuum. The synthesized monomer can be covered with aluminum foil to protect it from light and dried overnight in a vacuum oven. A yellow liquid is obtained as a final product.

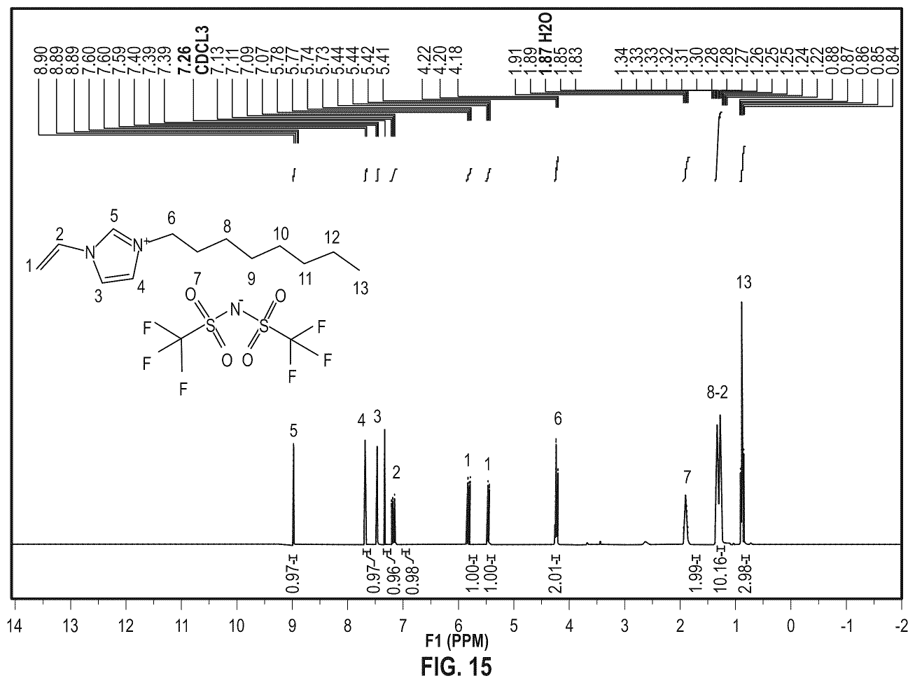

FIG. 15 is the ¹H NMR spectrum of [OVIM][NTf₂] IL. ¹H NMR (400 MHZ, chloroform-d): δ (ppm) 0.87-0.90 (t, 3H), 1.22-1.42 (m, 10H), 1.93-2.01 (m, 2H), 4.41-4.44 (m, 2H), 5.97-6.02 (d, ¹H), 7.48-7.55 (m, 2H), 7.78 (s, ¹H), 11.11 (s, ¹H).

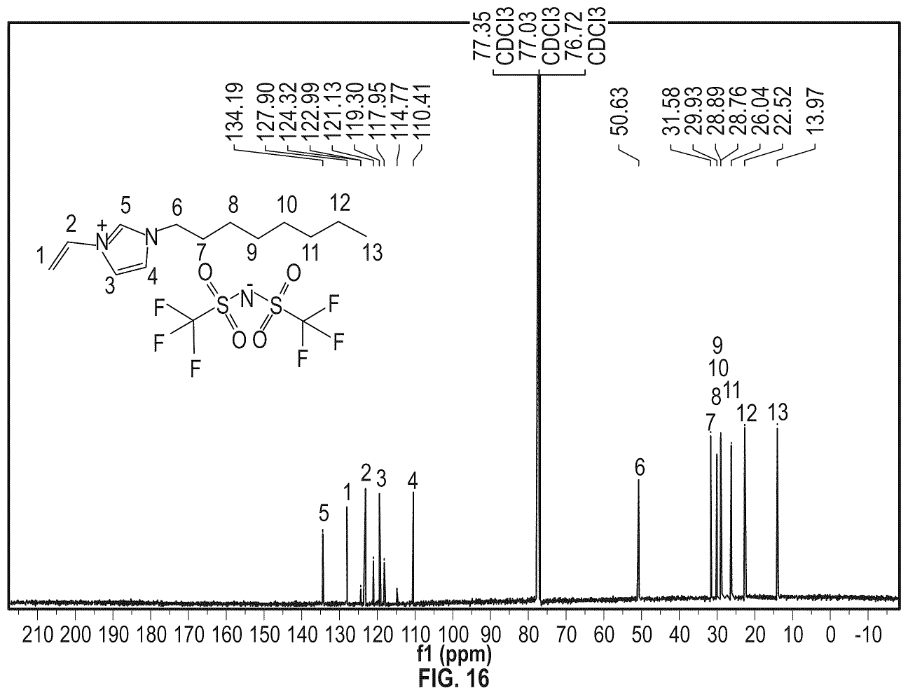

FIG. 16 is. ¹C NMR spectrum of [OVIM][NTf₂] IL. ¹³C NMR (400 MHZ, chloroform-d): δ (ppm) 13.97, 22.52, 26.04, 28.76, 28.89, 29.93, 31.58, 50.63, 110.41, 117.95, 119.30, 121.13, 122.99, 127.90, 134.19. The water content for this IL was found to be less than 0.1% (w/w).

### EXAMPLE 3

### Preparation of a Prepolymer Mixture for 3D Printing

The next step is the preparation of a prepolymer mixture for 3D printing. The prepolymer mixture in this illustrative, but nonlimiting, example can include three main components, including the prepolymer monomer (IL monomer) ([OVIM][Br] or [OVIM][NTf2]), DUDMA crosslinker, and TPO photoinitiator. The chemical structures of these two IL monomers are shown in Table 2 below.

TABLE 2
This study examines the IL monomers' abbreviations, names, and chemical structures
of the IL monomers for creating 3D-printed PIL sorbents.

| Abbreviation | Name | Cation | Anion |
|---|---|---|---|
| [OVIM][Br] | 1-octyl-3- vinylimidazolium bromide | 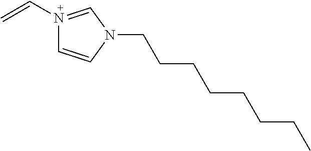 | Br⁻ |
| [OVIM][NTf₂] | 1-octyl-3- vinylimidazolium bis[(trifluoromethyl) sulfonyl]imide | 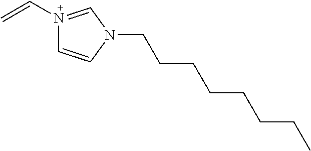 | 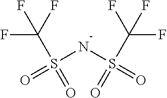 [SMILES: O=S(=O)(NS(=O)(=O)C(F)(F)F)C(F)(F)F] |

A total of three IL-based prepolymer mixtures were prepared according to the compositions listed in Table 3 below.

TABLE 3
The composition of the IL prepolymer mixture
used in the preparation of the PIL 1, PIL 2,
and PIL 3 sorbents was examined in this study.

| | Sorbent | | |
|---|---|---|---|
| | | PIL 2 | |
| | | (2a, 2b, 2c, 2d, | |
| Composition | PIL 1 | 2e, 2f, 2g) | PIL 3 |
| Monomer | [OVIM][Br] | [OVIM][Br] | [OVIM][NTf₂] |
| % monomer | 50 | 85 | 85 |
| (w/w) | | | |
| Crosslinker | DUDMA | DUDMA | DUDMA |
| % crosslinker | 47 | 12 | 12 |
| (w/w) | | | |
| Photoinitiator | TPO | TPO | TPO |
| % photoinitiator | 3 | 3 | 3 |
| (w/w) | | | |

DUDMA is diurethane dimethacrylate, and TPO is diphenyl(2,4,6-trimethylbenzyl) phosphine.

An illustrative, but nonlimiting, procedure that can be used for preparing the prepolymer mixture involves placing a given mass of TPO in a 10-milliliter glass vial, followed by dissolving in 40 microliters of MeOH, the addition of DUDMA followed by either [OVIM][Br] or [OVIM][NTf₂] IL. The mixture was subjected to a three-minute vortex to ensure all components were homogenously mixed and then covered with aluminum foil and degassed by sonication for twenty minutes at 25° C.

### EXAMPLE 4

### Designing, Fabricating, and Characterizing 3D-Printed PIL Sorbents

The next step is designing, fabricating, and characterizing 3D-printed PIL sorbents. In this illustrative but nonlimiting example, software, e.g., Autodesk Inventor®, first modeled the PIL sorbents to produce two different form factors. The 3D-printed blade-type sorbents featured dimensions resembling metal blades used in thin-film microextraction (TFME), and cylindrical sorbents were used as solid-phase microextraction (SPME) fibers. The 3D printed blades and fibers are not limited in geometric configuration; for example, geometric configurations can include, but are not limited to, planar configurations, rectangular configurations, cylindrical configurations, cuboid configurations, capsule configurations, etc. Further, the 3D printed blades and fibers are not limited by the extraction configuration; for example, suitable extraction configurations can include, but are not limited to, in-tube SPME, paper-like sorbent extractions, or extraction tubings to sample air.

The PIL includes at least one cationic component comprising an ionic liquid, (IL), and one or more anionic components, wherein the anionic components can be the same or different. The cationic component comprises at least one or more of quaternary ammonium, protonated tertiary amine, thionium, phosphonium, arsonium, carboxylate, sulfate or sulfonate groups which may be substituted or unsubstituted, saturated or unsaturated, linear, branched, cyclic, or aromatic. Saturated or unsaturated, linear, branched, cyclic or aromatic. The cationic component comprises one or more imidazolium-based monomers, including functionalized imidazolium, pyridinium, triazolium, pyrrolidinium, and ammonium. The cationic component also includes at least one or more: quaternary ammonium, protoated tertiary amine, thionium, phosphonium, arsonium, carboxylate, sulfate or sulfonate groups which may be substituted or unsubstituted, saturated or unsaturated, linear, branched, cyclic, or aromatic.

The PILs can be comprised of one or more of: imidazolium-based monomers, including functionalized imidazolium, pyridinium, thiazolium, pyrrolidinium, ammonium cations with anions including, but not limited to: Cl⁻, Br⁻, I⁻, bis[(trifluoromethyl)sulfonyl]imide, PF₆⁻, BF₄⁻, CN⁻, SCN⁻. Further, in certain embodiments, the polymeric ionic liquids comprise one or more of: 1-vinyl-3-hexylimidazolium chloride; 1-vinyl-3-dodecylimidazolium bromide, and 1-vinyl-3-hexadecylimidazolium bromide.

The PIL can be polymerized to form linear polymers and/or crosslinked using varying ratios of monocationic/dicationic/tricationic/multicationic crosslinking molecules. Further details can be found in US Published Patent Application No. 2015/0119231, Anderson, which was published on Apr. 30, 2015, and is incorporated herein by reference in its entirety.

Moreover, the anionic component of a PIL can include a taurate component. In addition, the cationic component may also include imidazolium (IM) or substituted IM, pyrrolidinium or substituted pyrrolidinium, or pyridinium or substituted pyridinium as well as one or more of: monocationic components, dicationic components, tricationic components, other multicationic components, and mixtures thereof. Additionally, the cationic component can include an IL monomer modified through one or more incorporations of alkyl chains having different lengths, aromatic components, and/or hydroxyl-functionality. Moreover, the cationic component can be described by the general formula of (XRR′R″H)⁺, where X is N, P, or As' and wherein each of R, R′, R″ is selected from the group consisting of one or more of: a proton, an aliphatic group, a cyclic group, and an aromatic group. Furthermore, the cationic component can include one or more of: VHIM⁺, VDDIM⁺, VHDIM⁺, or BBIM⁺. Further details can be found in U.S. Pat. No. 9,782,746, Anderson et al., issued on Oct. 17, 2017, and was filed on Dec. 15, 2015, and is incorporated herein by reference in its entirety. Numerous examples of iconic liquids can be utilized with this technology found in these two references cited above.

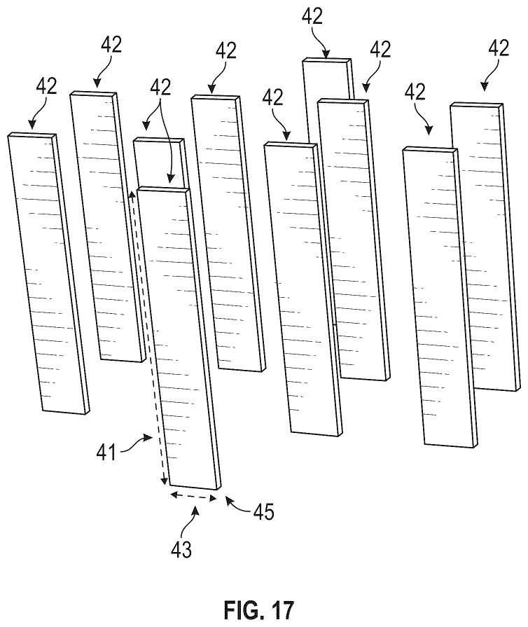

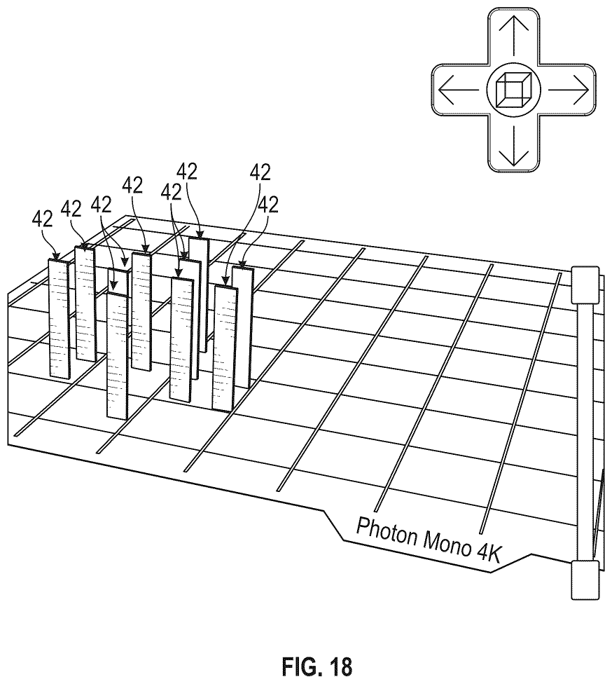

FIGS. 17-20 show schematics of the digital model and printing setup for 3D printed blade and fiber PIL sorbents. Referring now to FIG. 17, there are ten cuboids representing blade-type sorbent 42 that were created using software, e.g., Autodesk Inventor®, to have preferable dimensions of 15 millimeters (L)×2.5 millimeters (W)×0.5 millimeters (H) but can be in a range from about 0.1 mm to about 1 m (L) indicated by numeral 41, from about 0.5 mm to about 1 m (W) indicated by numeral 43 and from about 0.1 mm to about 1 m (H) indicated by numeral 45, Referring now to FIG. 18, the digital files of the ten cuboids representing blade-type sorbent 42 were sent to a software slicer, e.g., Photon® Workshop, to set up the printing parameters for printing with the LCD 3D printer, e.g., Photon Mono® 4K LCD 3D printer. Photon Mono® and Photon® are federally registered trademarks owned by Shenzhen Anycubic Technology Co., Ltd., having a place of business at 1-2/F, BLDG G2, 2nd Industrial Zone ShenKeng Village, Henggang ST, Longgang District, Shenzhen China 518000.

Referring now to FIG. 19, there are twelve cylinders representing blade-type sorbent 44 were created using software, e.g., Inventor software™M, that preferably have a diameter of 0.6 millimeters with a length of 1.2 centimeters but can be in a range from about 0.5 mm to about 1 m in diameter indicated by numeral 47 and from about 0.1 mm to about 1 m in length (L) indicated by numeral 49.

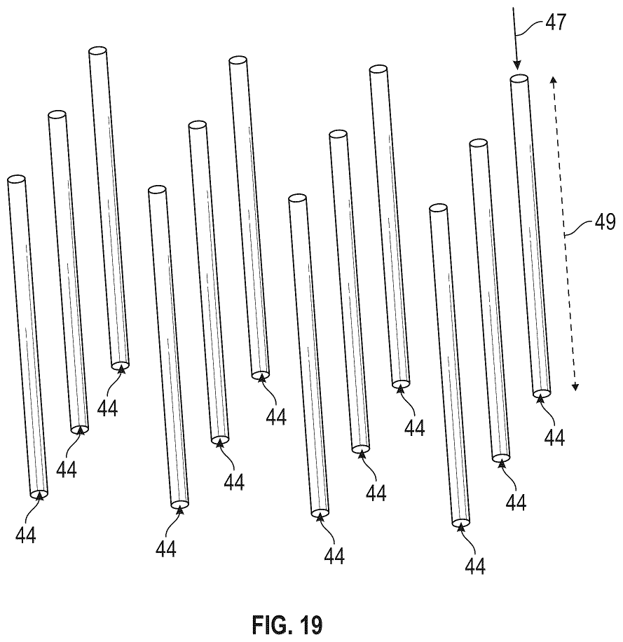

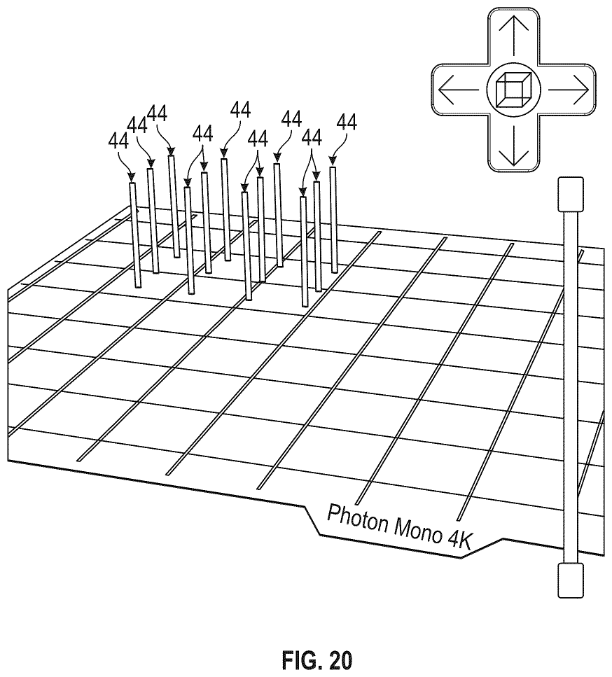

Referring now to FIG. 20, the digital files of the twelve cylinders representing blade-type sorbent 44 were sent to a software slicer, e.g., Photon® Workshop, to set up the printing parameters for printing with the LCD 3D printer, e.g., Photon Mono® 4K LCD 3D printer.

The printing parameters include a layer exposure time of four seconds (PIL 1) or seven seconds (PIL 2 and PIL 3), a bottom exposure time of twenty seconds, and a z-axis lifting time of 0.5 seconds. An approximate one-milliliter volume of prepolymer mixture was used for the twenty-four well cell plate 30 functioning as a printing platform, while approximately four milliliters were used for the six well cell plate 26 functioning as a printing platform. After the printing process was complete, the sorbents were placed in 100% ACN for ten minutes to remove any uncured residual resin. Post-curing of the sorbents was carried out in an Anycubic® Cure station using a UV wavelength of 405 nanometers for thirty minutes at room temperature. Anycubic® is a federally registered trademark of Shenzhen Anycubic Technology Co., Ltd. limited company (ltd.), having a place of business at 1-2/F, BLDG G2, 2nd Industrial Zone, Shenkeng VIL, Henggang ST, Longgang District, Shenzhen, Guangdong CHINA 518173.

### EXAMPLE 5

### Morphology and Layer Thicknesses of PIL Sorbents

The morphology and layer thicknesses of the final printed PIL sorbents were determined by scanning electron microscopy (SEM). An illustrative, but nonlimiting example includes a JEOL® HSM-IT200 microscope (Peabody, MA, USA). JEOL® is a federally registered trademark of Jeol, Ltd., having a place of business at 3-1-2 Musahino, Akishima, Tokyo, Japan 196-8558.

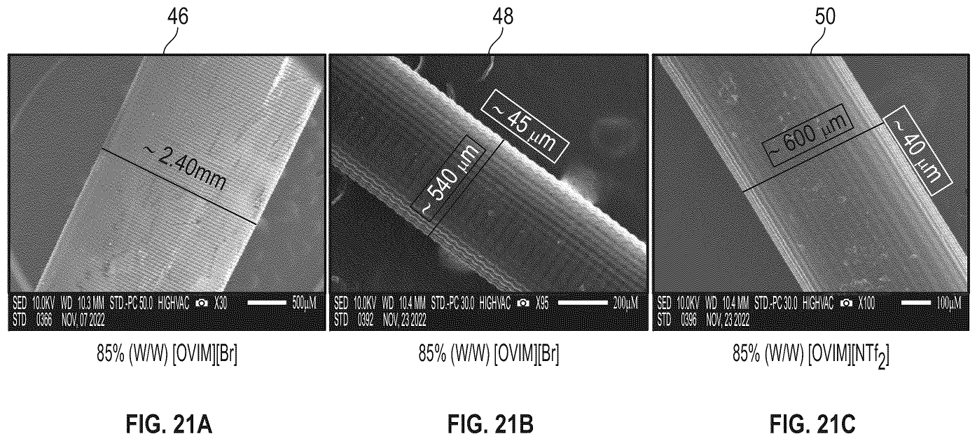

The layer morphology of the printed sorbents is shown in FIGS. 21A-C. Scanning electron micrographs (SEM) showing the 3D printed blade 46 and fiber PIL 48 sorbents consisting of 85% (w/w) [OVIM][Br] IL, 12% (w/w) DUDMA, and 3% (w/w) TPO and fiber sorbent 50 consisting of 85% (w/w) [OVIM][NTf₂] IL, 12% (w/w) DUDMA, and 3% (w/w) TPO. The digital models were created with a width of 2.5 millimeters for the blade and a diameter of 600 micrometers for the cylinder. For the 3D printed blade indicated by numeral 46 and fiber PIL indicated by numeral 48, the actual print dimensions were measured to have an approximate width of 2.4 millimeters for the 3D printed PIL blade and a diameter of 540 micrometers for the 3D printed PIL cylinder. The thickness of each layer was found to be 45 micrometers in this composition when the UV light exposure time was set to expose four seconds per layer. For fiber sorbent 50, the actual print dimension was measured to have an approximate diameter of 600 micrometers for the 3D-printed PIL cylinder and a layer thickness of 40 micrometers. To achieve this thickness, the UV light exposure time was set to expose seven seconds per layer for this composition.

### EXAMPLE 6

### 3D Printability of PILs

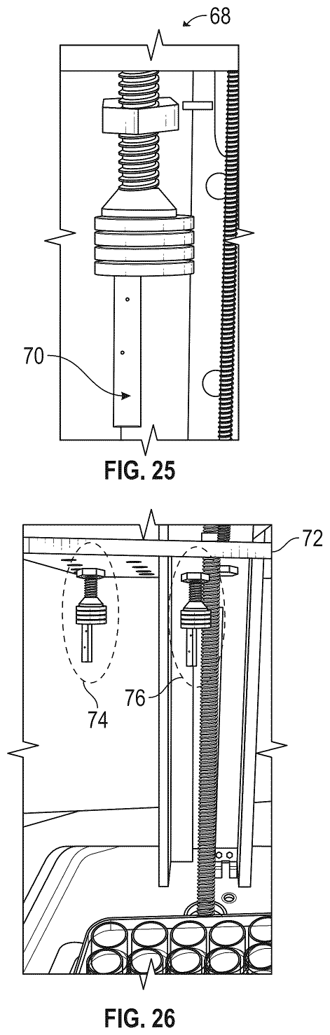

The 3D printability of PILs was tested by printing three different prepolymer mixture compositions, as provided in Table 3 above. Based on previous studies employing PILs as sorbent coatings, the extraction and desorption of targeted analytes can be varied using ILs featuring different anions. Therefore, hydrophilic ([OVIM][Br]) and hydrophobic ([OVIM][NTf2]) IL monomers were examined. As shown in FIG. 25, an initial test was carried out by printing a blade sorbent with one milliliter of PIL 1, see Table 3 above, using the 24-well modified platform for small-scale printing. As an illustrative example, a blade 70 can be printed with a dimension of 15 millimeters (L)×2.5 millimeters (W)×0.5 millimeters (H) using approximately 1 milliliter of prepolymer mixture consisting of 50% (w/w) of [OVIM][Br] IL, 47% (w/w) DUDMA, and 3% (w/w) TPO.

The amount of IL in the prepolymer mixture was then increased to 85% (w/w) to enhance the IL content for extraction purposes. As shown in FIG. 26 and generally indicated by numeral 72, sorbents comprising the composition of PIL 2 and PIL 3, see Table 3 above, could both be printed, highlighting the versatility of this modified platform. An additional limitation of commercial resin 3D printers is that they can only print a single material during each printing run. However, the approach developed circumvents this limitation and permits various prepolymer compositions to be printed and tested simultaneously. This is a notable advantage and can minimize tedious troubleshooting that is often encountered when trying to print multiple materials, while also accelerating the speed at which new types of resin materials are developed. Simultaneous printing with different prepolymer mixtures with compositions of 50% (w/w) of [OVIM][Br], 47% (w/w) DUDMA, and 3% (w/w) TPO indicated by numeral 74 and 85% (w/w) of [OVIM][Br], 12% (w/w) DUDMA, and 3% (w/w) TPO indicated by numeral 76.

### EXAMPLE 7

### 3D Printing PIL Sorbents with Different Form Factors

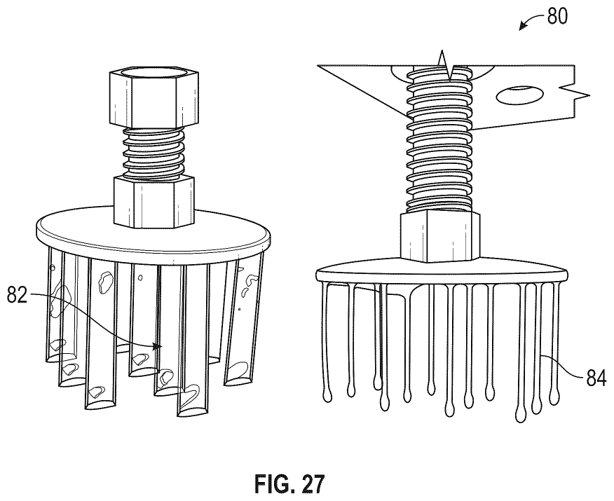

Finally, an investigation into printing PIL sorbents with different form factors was undertaken. 3D printing permits the creation of unique geometries that may be challenging to achieve using traditional manufacturing methods. FIG. 27, as generally indicated by numeral 80, illustrates the versatility of fabricating both blade 82 and fiber PIL sorbents 84, showcasing the potential of this technology in tailoring the shape, size, and composition of the extraction devices. The batch printing of PIL sorbents features two different form factors. A total of ten blade sorbents 82 and twelve fiber PIL sorbents 84 were printed simultaneously. The fiber PIL sorbents were printed with a circular diameter of 600 micrometers and a length of 12 millimeters.

The next step is assembling the extraction device containing the 3D printed PIL SPME fiber. An extraction device was designed and constructed to enable the extraction and desorption of the 3D printed sorbents.

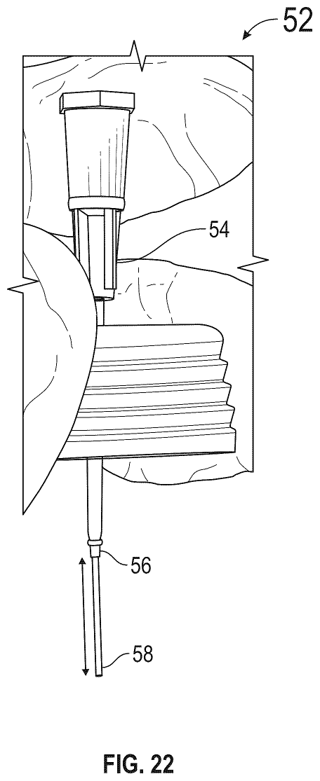

As shown in FIG. 22, the assembly of an extraction device with 3D printed PIL sorbent is generally indicated by numeral 52 and includes the 3D printed fiber sorbent 58, a blunt tip syringe needle 56, e.g., 18 G, and steel-reinforced epoxy glue 54. An illustrative, but nonlimiting, example of epoxy glue 54 includes JB Weld®. JB Weld® is a federally registered trademark of JB Weld Company, LLC, having a place of business at 1675 Broadway, Suite 1200, Denver, Colorado 80202.

Epoxy glue 54 was first manually mixed at a 1:1 volume ratio from the steel (black) and the hardener tubes (white) until the mixture turned a homogenous grey color. The 3D-printed sorbent 58 was carefully glued and inserted into the blunt tip syringe needle 56, allowing one centimeter of the 3D-printed sorbent to be exposed for extraction/desorption studies. After assembly of the devices, epoxy glue 54 was allowed to cure for forty-eight hours at room temperature.

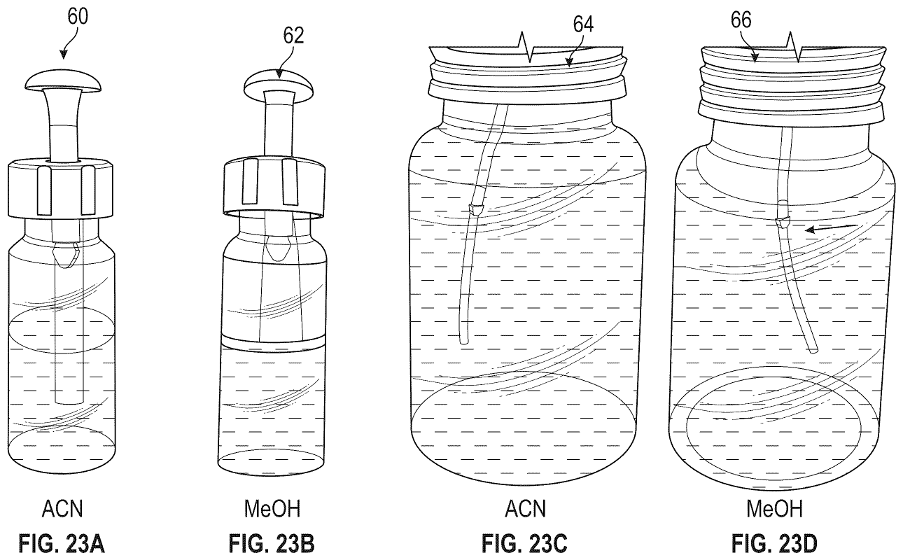

The next step is solvent compatibility and extraction/desorption conditions for 3D-printed PIL-based sorbents. The 3D-printed PIL sorbents consisted of 85% (w/w) [OVIM][Br] IL, 12% (w/w) DUDMA, and 3% (w/w) TPO. The blade and fiber PIL sorbents fabricated with prepolymer compositions of PIL 2 and PIL 3, as shown in Table 3 above, are used to examine their compatibility with organic solvents. The compatibility of PIL 2 and PIL 3 sorbents with organic solvents was examined prior to extraction/desorption experiments using MeOH and ACN. As shown in FIGS. 23A-D, the blade exposed to MeOH 62 swelled to nearly two times the original size, while the blade exhibited minimal changes when exposed to ACN 60. One of the 3D-printed blades was placed in one milliliter of ACN 60, and another blade was placed in one milliliter of MeOH 62 for fifteen minutes. A 3D-printed fiber sorbent was placed in ten milliliters of ACN 64, and another fiber sorbent was placed in ten milliliters of MeOH 66 for fifteen minutes. Significant swelling of the blade was observed when it was placed in MeOH, whereas the fiber sorbent exhibited signs of breakage. Furthermore, it was observed that the structural rigidity and strength of the sorbent decreased significantly in MeOH, ultimately resulting in the fracturing of the sorbent.

It was observed that the PIL 3 blade and fiber sorbents experienced diminished structural rigidity when exposed to both organic solvents, indicating that this PIL composition is not ideal for subsequent HPLC analysis. Therefore, all extraction studies were performed with a prepolymer mixture consisting of 85% (w/w) [OVIM][Br] IL, 12% (w/w) DUDMA, and 3% (w/w) TPO (PIL 2) with ACN used for sorbent conditioning and analyte desorption.

Referring again to FIGS. 23A-D, a blade was half-immersed in ACN 60 for the blade sorbents, and another was half-immersed in MeOH 62 for fifteen minutes. For the PIL fiber sorbents, one sorbent was examined by its full immersion into 10 milliliters of ACN 64, while another sorbent was fully immersed into 10 milliliters of MeOH 66 for fifteen minutes. Significant swelling of the blade was observed when it was placed in MeOH, whereas the fiber sorbent exhibited signs of breakage.

Prior to extraction, the printed fiber sorbent underwent an initial conditioning step by immersing them into 15 milliliters of ACN for fifteen minutes. Extractions were performed in 18-millimeter screw cap vials with PTFE/butyl septa cap (18 millimeters). An illustrative but nonlimiting example of the vial and screw cap can be purchased from Restek Corporation, having a place of business located at 110 Benner Circle, Bellefonte, Pennsylvania 16823.

A 15 milliliter volume of water was spiked with the analytes at 500 micrograms/liter and stirred for two minutes prior to performing each extraction. The sorbent was directly immersed into the sample solution for sixty minutes at a stirring rate of 1000 rpm at room temperature. A 250 microliter deactivated conical glass insert with polymer feet is utilized for desorption. An illustrative, but nonlimiting, example of polymer feet optionally includes those from Agilent Technologies, having a place of business at 5301 Stevens Creek Blvd, Santa Clara, California 95051, which was placed in a ten millimeter screw cap glass vial and served as a desorption vessel. A 100 microliter volume of ACN was pipetted into the glass insert, followed by full immersion of the sorbent. The extracted analytes were desorbed from the sorbent for fifteen minutes without agitation.

After desorption, the glass insert was placed into a two-milliliter screw top vial, e.g., Agilent Technologies, and capped with a PTFE/silicone screw cap. The two-milliliter glass vial was then placed into a G1367E 1260 HiP autosampler coupled to a High-Performance Liquid Chromatography with Diode-Array Detection (HPLC-DAD) system. An illustrative, but nonlimiting, example of a HPLC-DAD system for separation and analysis is an Agilent Technologies 1260 HPLC-Diode-Array Detection (HPLC-DAD) system. To avoid analyte carryover, two cleaning steps of fifteen minutes each using ten milliliters of ACN were performed between each extraction. It should be understood that a variety of analytical instruments can be used at this phase and the methods are not limited by analytical instruments. Preferred analytical instruments include, but are not limited to, a high performance liquid chromatography instrument (“HPLC”), an ultra-performance liquid chromatography instrument (“UPLC”), a next generation chromatograph (“NGC”), a mass spectrometer (“MS”), a gas chromatograph (“GC”), a colorimeter, a mass spectrometer, a fluorometer, a photometer, a spectrometer, a spectrophotometer, a X-ray photoelectron spectrometer (“XPS”), or a combination thereof.

### EXAMPLE 8

### Separation Using a Column

Injection volumes of twenty microliters were subjected to separation using a column. An illustrative, but nonlimiting, example of a column includes the Raptor® C18 column (25 centimeters length×4.6 millimeters inner diameter, and a particle size of 5 micrometers) at 25° C. Raptor® is a federally registered trademark of the Restek Corporation, having a place of business at 110 Benner Circle, Bellefonte, Pennsylvania 16823.

A gradient program began with 40% mobile phase A (water+0.1% (v/v) formic acid) and 60% mobile phase B (ACN+0.1% (v/v) formic acid). The percentage of mobile phase B was linearly increased to 100% over fourteen minutes and held for an additional fourteen minutes. The total run time for the separation of analytes was 28 millimeters. The flow rate was kept constant at 1 milliliter/minute. The analytes were monitored at UV detection wavelengths of 220, 254, and 305 nanometers in Table 4 on the next page.

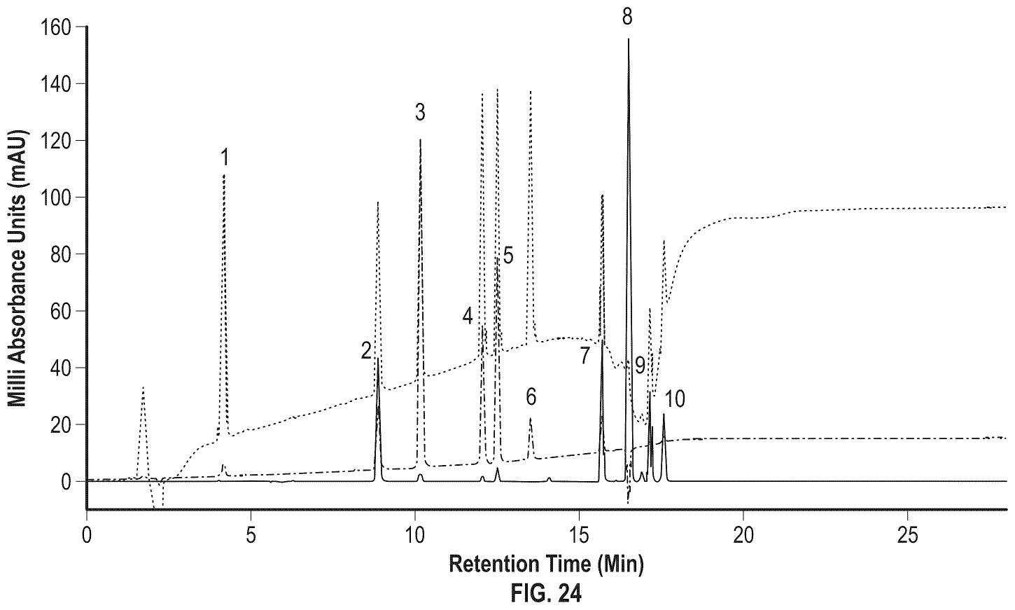

Representative chromatograms are shown in FIG. 24. Overlaid chromatograms were obtained at 220 nm (blue), 254 nm (green), and 305 nm (red) after direct injection of analytes. The final separation program used an initial composition of 40% mobile phase A (water+0.1% (v/v) formic acid) and 60% B (ACN+0.1% (v/v) formic acid). Mobile phase B was linearly increased to 100% over fourteen minutes and held for fourteen minutes. An injection volume of 20 microliters was used. A standard of all analytes at a concentration of 10 μg mL⁻¹ was injected. Peak identification: (1) bisphenol A, (2) triclocarban, (3) chlorfenapyr, (4) flufenoxuron, (5) hexythiazox, and (6) oxybenzone, (7) octocrylene, (8) padimate-O, (9) 2-ethylhexyl salicylate, and (10) homosalate.

TABLE 4
List of analytes examined as well as their chemical structures, chromatographic
retention times, CAS numbers, detection wavelengths used in HPLC-DAD, log P values,
and pKa values.

| | | | | | Detec- | | |
|---|---|---|---|---|---|---|---|
| | | | Reten- | | tion• | | |
| | Abbre- | | tion• | | wave- | | |
| | viations | | time• | | length• | Log•P | |
| Names [symbol] | [symbol] | Structures [symbol] | (min) [symbol] | CAS [symbol] | (nm) [symbol] | [symbol] | pKa [symbol] |
| Bisphenol- A [symbol] | BPA [symbol] | 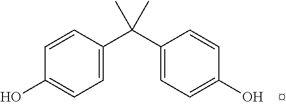 [SMILES: CC(C)(c1ccc(O)cc1)c1ccc(O)cc1] | 4.16 [symbol] | 80- 05-7 [symbol] | 220 [symbol] | 2.2 [symbol] | 9.59 [symbol] |
| Oxy- benzone [symbol] | BP-3 [symbol] | 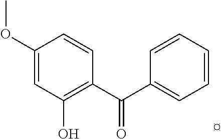 [SMILES: COc1ccc(C(=O)c2ccccc2)c(O)c1] | 8.85 [symbol] | 131- 57-7 [symbol] | 305 [symbol] | 3.62 [symbol] | 7.07 [symbol] |
| Tri- clocarban [symbol] | TCC [symbol] | 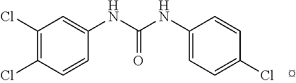 [SMILES: O=C(Nc1ccc(Cl)cc1)Nc1ccc(Cl)c(Cl)c1] | 10.13 [symbol] | 101- 20-2 [symbol] | 254 [symbol] | 4.90 [symbol] | 12.7 [symbol] |
| Chlor- fenapyr [symbol] | CFP [symbol] | 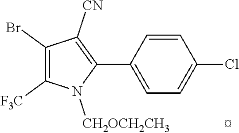 | 12.05 [symbol] | 122453- 73-0 [symbol] | 254 [symbol] | 4.88 [symbol] | [symbol] |
| Flufen- oxuron [symbol] | FFN [symbol] | 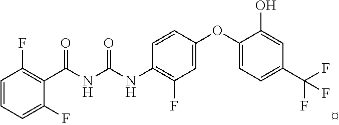 [SMILES: O=C(NC(=O)c1c(F)cccc1F)Nc1ccc(Oc2ccc(C(F)(F)F)cc2O)cc1F] | 12.51 [symbol] | 101463- 69-8 [symbol] | 254 [symbol] | 4.81 [symbol] | 10.1 [symbol] |
| Hexy- thiazox [symbol] | HTZ [symbol] | 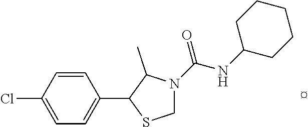 [SMILES: CC1C(c2ccc(Cl)cc2)SCN1C(=O)NC1CCCCC1] | 13.53 [symbol] | 78587- 05-0 [symbol] | 254 [symbol] | 5.03 [symbol] | 12.77 [symbol] |
| Octo- crylene [symbol] | OCR [symbol] | 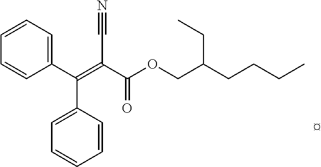 [SMILES: CCCCC(CC)COC(=O)C(C#N)=C(c1ccccc1)c1ccccc1] | 15.69 [symbol] | 6197-30- 4-2 [symbol] | 305 [symbol] | 6.78 [symbol] | [symbol] |
| Padimate- O [symbol] | PADO [symbol] | 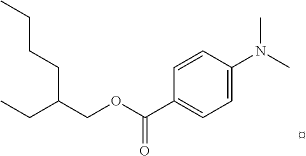 [SMILES: CCCCC(CC)COC(=O)c1ccc(N(C)C)cc1] | 16.52 [symbol] | 21245- 02-3 [symbol] | 305 [symbol] | 5.41 [symbol] | 6.03 [symbol] |
| 2-Ethyl- hexyl- salicylate [symbol] | EHS [symbol] | 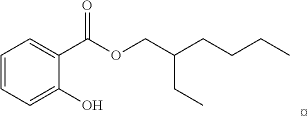 [SMILES: CCCCC(CC)COC(=O)c1ccccc1O] | 17.14 [symbol] | 118- 60-5 [symbol] | 305 [symbol] | 5.93 [symbol] | 8.13 [symbol] |
| Homo- salate [symbol] | HMS [symbol] | 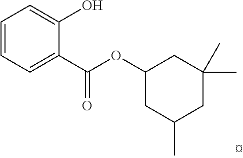 [SMILES: CC1CC(OC(=O)c2ccccc2O)CC(C)(C)C1] | 17.56 [symbol] | 118- 56-9 [symbol] | 305 [symbol] | 6.16 [symbol] | 8.09 [symbol] |

[symbol]

indicates data missing or illegible when filed

### EXAMPLE 9

### Validation of Method Using 3D Printed Fiber Sorbents for HPLC Analysis

The method developed using 3D printed fiber sorbents for HPLC analysis was validated in terms of linearity, limits of detection (LOD), limits of quantification (LOQ), and precision, as shown in Tables 5 and 6 below.

Table 5 below shows the figures of merit of the method using a 3D printed sorbent for the analysis of target analytes. A sorbent consisting of 85% (w/w) [OVIM][Br], 12% (w/w) DUDMA, and 3% (w/w) TPO was used. The linear ranges, slopes, coefficient of determination, Y-intercept, LOD, and LOQ values are shown. Triplicate extractions were performed at each concentration.

TABLE 5

| | Linear | | | | | |
|---|---|---|---|---|---|---|
| | range | | | | LOD | LOQ |
| Analytes | (μg L⁻¹) | Slope ± SD | R² | Y-intercept ± SD | (μg L⁻¹) | (μg L⁻¹) |
| BPA | 200-600 | 0.096 ± 0.005 | 0.993 | 1.701 ± 2.204 | 45 | 150 |
| BP-3 | 10-600 | 0.168 ± 0.012 | 0.969 | 0.132 ± 4.156 | 1.60 | 5.32 |
| TCC | 50-600 | 0.625 ± 0.054 | 0.957 | 16.916 ± 18.384 | 3.95 | 13.1 |
| CFP | 10-600 | 0.186 ± 0.015 | 0.986 | −2.084 ± 5.425 | 3 | 10 |
| FFN | 10-600 | 0.147 ± 0.007 | 0.991 | 10.98 ± 12.82 | 1.32 | 4.5 |
| HTZ | 50-600 | 0.052 ± 0.006 | 0.956 | −1.431 ± 2.168 | 15 | 50 |
| OCR | 10-600 | 0.121 ± 0.012 | 0.944 | 5.011 ± 5.228 | 0.53 | 1.78 |
| PADO | 10-600 | 0.113 ± 0.007 | 0.977 | 3.988 ± 4.339 | 0.13 | 0.43 |
| EHS | 10-600 | 0.111 ± 0.0007 | 0.974 | 4.863 ± 5.460 | 0.84 | 2.79 |
| HMS | 10-600 | 0.115 ± 0.012 | 0.926 | −1.564 ± 4.068 | 1.34 | 4.48 |

R² is the coefficient of determination, SD is the standard deviation, LOD is the limit of detection, calculated as a signal-to-noise ratio of three, and LOQ is the limit of quantification, calculated as a signal-to-noise ratio of 10.

Table 6, recited below, provides intra-sorbent precision of peak areas for target analytes using different prepolymer mixtures containing 85% (w/w) [OVIM][Br], 12% (w/w) DUDMA, and 3% (w/w) TPO. The PIL 2a, PIL 2b, and PIL 2c sorbents were printed simultaneously in the same well, whereas PIL 2d and PIL 2e were printed simultaneously as PIL 2a from different wells. The PIL 2f and PIL 2g sorbents were obtained from different printing times compared to PIL 2a. Extraction conditions include a concentration of analytes: 500 μg L⁻¹ for all analytes; Sample volume is fifteen mL; Stirring rate is 1000 rpm; Extraction time is 60 minutes; Temperature is 22° C.; Static desorption volume is 100 μL; Desorption solvent is ACN; Desorption time is fifteen minutes; and Desorption temperature is 22° C. The ten analytes include: bisphenol A (BPA), oxybenzone (BP-3), triclocarban (TCC), chlorfenapyr (CFP), flufenoxuron (FFN), hexythiazox (HTZ), octocrylene (OCR), padimate-O (PADO), 2-ethylhexyl salicylate (EHS), and homosalate (HMS). All extractions were performed in triplicate.

TABLE 6

| | PIL 2a | | | PIL 2b | | | PIL 2c | | |
|---|---|---|---|---|---|---|---|---|---|
| Analytes | Average | SD | % RSD | Average | SD | % RSD | Average | SD | % RSD |
| BPA | 52.887 | 6.230 | 11.780 | 46.687 | 3.880 | 8.310 | 38.267 | 3.933 | 10.279 |
| BP-3 | 45.297 | 3.153 | 6.960 | 44.327 | 3.969 | 8.955 | 37.887 | 2.943 | 7.768 |
| TCC | 239.563 | 14.865 | 6.205 | 256.547 | 16.949 | 6.607 | 265.930 | 16.260 | 6.114 |
| CFP | 45.633 | 3.630 | 7.955 | 50.557 | 4.482 | 8.866 | 44.187 | 3.077 | 6.963 |
| FFN | 48.937 | 8.524 | 17.419 | 43.033 | 7.466 | 17.349 | 42.430 | 2.472 | 5.825 |
| HTZ | 13.433 | 1.184 | 8.818 | 13.933 | 0.520 | 3.732 | 12.510 | 1.265 | 10.108 |
| OCR | 28.777 | 3.893 | 13.528 | 31.270 | 6.189 | 19.793 | 25.120 | 3.955 | 15.746 |
| PADO | 145.073 | 15.109 | 10.415 | 155.530 | 22.770 | 14.640 | 139.257 | 19.693 | 14.142 |
| EHS | 32.530 | 2.393 | 7.356 | 35.077 | 4.562 | 13.007 | 29.493 | 3.898 | 13.217 |
| HMS | 22.690 | 1.915 | 8.440 | 24.690 | 3.622 | 14.670 | 20.610 | 2.542 | 12.333 |
| | PIL 2a | | | PIL 2d | | | PIL 2e | | |
| Analytes | Average | SD | % RSD | Average | SD | % RSD | Average | SD | % RSD |
| BPA | 52.887 | 6.230 | 11.780 | 44.913 | 1.533 | 3.414 | 40.687 | 2.087 | 5.129 |
| BP-3 | 45.297 | 3.153 | 6.960 | 46.703 | 4.677 | 10.014 | 46.217 | 3.229 | 6.986 |
| TCC | 239.563 | 14.865 | 6.205 | 229.120 | 16.431 | 7.171 | 226.197 | 40.506 | 17.907 |
| CFP | 45.633 | 3.630 | 7.955 | 38.380 | 3.755 | 9.784 | 53.293 | 8.457 | 15.870 |
| FFN | 48.937 | 8.524 | 17.419 | 34.777 | 2.553 | 7.342 | 49.467 | 4.535 | 9.167 |
| HTZ | 13.433 | 1.184 | 8.818 | 11.933 | 0.742 | 6.219 | 14.517 | 1.206 | 8.307 |
| OCR | 28.777 | 3.893 | 13.528 | 25.017 | 2.729 | 10.911 | 31.293 | 4.266 | 13.633 |
| PADO | 145.073 | 15.109 | 10.415 | 127.010 | 13.090 | 10.306 | 176.653 | 17.583 | 9.953 |
| EHS | 32.530 | 2.393 | 7.356 | 29.420 | 3.330 | 11.319 | 35.930 | 5.180 | 14.416 |
| HMS | 22.690 | 1.915 | 8.440 | 19.523 | 2.271 | 11.632 | 24.793 | 3.216 | 12.973 |
| | PIL 2a | | | PIL 2f | | | PIL 2g | | |
| Analytes | Average | SD | % RSD | Average | SD | % RSD | Average | SD | % RSD |
| BPA | 52.887 | 6.230 | 11.780 | 40.147 | 5.189 | 12.924 | 51.060 | 2.825 | 5.533 |
| BP-3 | 45.297 | 3.153 | 6.960 | 44.500 | 2.198 | 4.939 | 38.840 | 2.085 | 5.367 |
| TCC | 239.563 | 14.865 | 6.205 | 188.817 | 17.286 | 9.155 | 189.587 | 10.415 | 5.494 |
| CFP | 45.633 | 3.630 | 7.955 | 55.273 | 2.579 | 4.666 | 43.273 | 2.008 | 4.640 |
| FFN | 48.937 | 8.524 | 17.419 | 63.513 | 6.120 | 9.635 | 57.327 | 4.714 | 8.224 |
| HTZ | 13.433 | 1.184 | 8.818 | 16.667 | 1.231 | 7.384 | 13.987 | 1.703 | 12.172 |
| OCR | 28.777 | 3.893 | 13.528 | 42.763 | 5.327 | 12.456 | 36.530 | 3.294 | 9.018 |
| PADO | 145.073 | 15.109 | 10.415 | 183.073 | 22.643 | 12.368 | 159.433 | 9.382 | 5.885 |
| EHS | 32.530 | 2.393 | 7.356 | 38.033 | 3.953 | 10.394 | 31.110 | 1.462 | 4.701 |
| HMS | 22.690 | 1.915 | 8.440 | 26.873 | 3.085 | 11.480 | 21.390 | 1.070 | 5.003 |

Linearity was evaluated with spiked water at five concentration levels for BPA (200, 300, 400, 500, and 600 μg L⁻¹), seven concentration levels for TCC and HTZ (50, 100, 200, 300, 400, 500, and 600 μg L⁻¹) and eight concentration levels (10, 50, 100, 200, 300, 400, 500, and 600 μg L⁻¹) for the remaining analytes. For each concentration level, triplicate measurements were performed. The coefficient of determination (R²), slope±standard deviation (SD), and Y-intercept±SD of the calibration curves were calculated. LOD and LOQ values were determined based on a signal-to-noise ratio (S/N) of 3 and 10, respectively. Precision was assessed intra and inter PIL sorbent by analyzing water spiked at 500 μg L⁻¹ for all analytes. It is believed that separate calibration curves are not needed for the precision of 3D printing. For intra-sorbent precision, three replicates were made, and the relative standard deviations (RSDs) of the peak areas were calculated. For the inter-fiber precision, a comparison of extraction efficiencies for the fiber sorbents printed from the same batch as well as from different batches were analyzed by principal component analysis (PCA) optionally using XLSTAT® software, version 2022.1.1 with a confidence interval of 95% was applied in all PCA score plots. Additionally, to evaluate the lifetimes of the PIL sorbents, the student's t-test was used to compare the extraction efficiencies prior to and after twenty extractions using the same PIL sorbents. XLSTAT® is a federally registered trademark of Addinsot société par actions simplifiée (sas), having a place of business at 40 rue Damremont F-75018 Paris, France.

To obtain a comparison of sorbent-to-sorbent extraction performance and assess the potential of high throughput fabrication of PIL-based extraction sorbents using 3D printers, the intra-sorbent precision of fiber sorbents printed in the same batch as well as those printed from different batches was evaluated by measuring their extraction efficiency of various analytes.

### EXAMPLE 10

### Fabrication of 3D Printed PIL Sorbents, Extraction/Desorption Studies, and HPLC Analysis

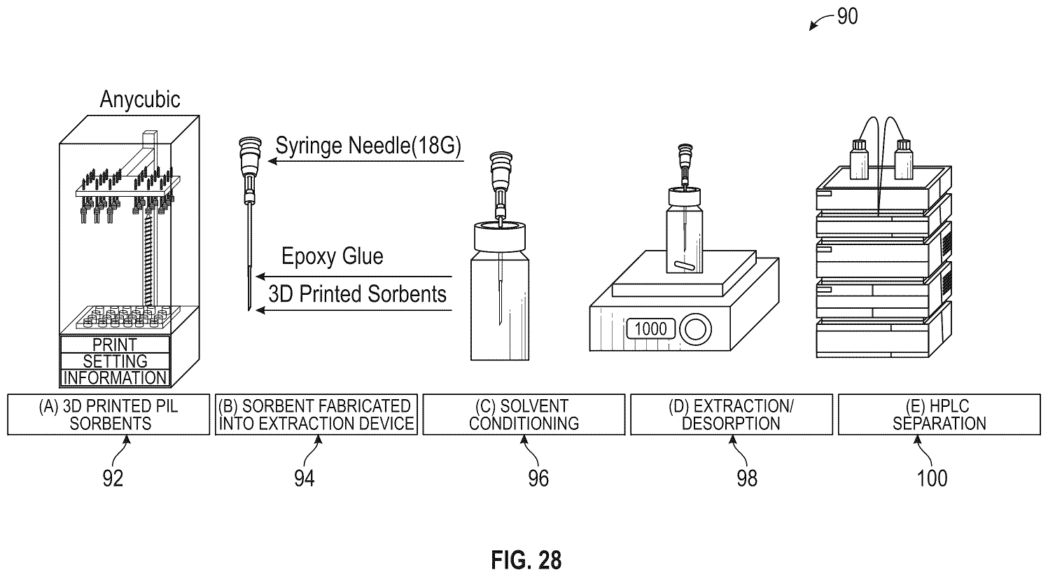

FIG. 28 shows a schematic procedure describing the sequential steps undertaken for the fabrication of 3D printed PIL sorbents, followed by employing them in extraction/desorption studies coupled to HPLC analysis, which is generally indicated by numeral 90. As shown in FIG. 28, the methods and systems include a 3D printer, an extraction device with a projectile (the projectile can be a syringe needle a hollow metal tube, or a non-hollow cylinder), epoxy glue. The overall procedure includes five steps, shown in FIG. 28, indicated by the numeral 90: 3D printing of PIL sorbents using a modified LCD 3D printer 92, e.g., an LCD Anycubic® Photon Mono 4K desktop 3D printer using a UV wavelength of 405 nm. An, illustrative, but nonlimiting example of a 3D printer, includes Anycubic Wash & Cure station, not shown, from Anycubic Technology Co., Ltd. (Shenzhen, China) was also utilized. Anycubic® is a federally registered trademark of Shenzhen Anycubic Technology Co., Ltd. limited company (ltd.), having a place of business at 1-2/F, BLDG G2, 2nd Industrial Zone, Shenkeng VIL, Henggang ST, Longgang District, Shenzhen, Guangdong CHINA 518173. The next step is the assembly of the extraction devices with an 18 G syringe needle, epoxy glue, and the prepared 3D-printed sorbent 94. This is followed by the conditioning of the sorbent in organic solvent 96. The fourth step is the extraction and desorption of analytes 98, and then the fifth step is separating and detecting analytes using HPLC-DAD 100.

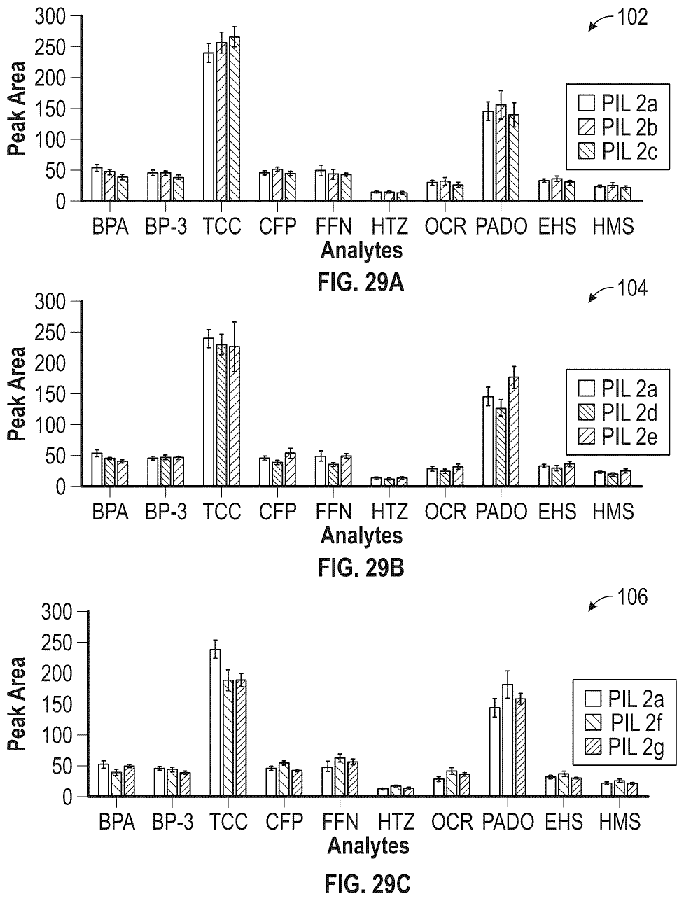

The first comparison was conducted with three fibers (PIL 2a, PIL 2b, and PIL 2c) printed simultaneously from the same well. As shown in FIGS. 29A-C and Table 6 above, there is a comparison of extraction efficiencies for 3D-printed fibers. Fibers PIL 2a, PIL 2b, and PIL 2c were obtained from the same printing well and printed at the same time 102. Fibers PIL 2a, PIL 2d, and PIL 2e were obtained from different printing wells and printed simultaneously 104. Fibers PIL 2a, PIL 2f, and PIL 2g were obtained from different printing wells and printed at different times 106. All sorbents are composed of 85% (w/w) [OVIM][Br] IL, 12% (w/w) DUDMA, and 3% (w/w) TPO. The concentration of analytes is 500 μg L⁻¹; Sample volume is 15 milliliters; Stirring rate is 1000 rpm; Extraction time is sixty minutes; Extraction temperature is 22° C.; Static desorption volume is 100 μL; Desorption solvent is ACN; Desorption time is 15 minutes; and Desorption temperature is 22° C. The ten analytes include: bisphenol A (BPA), oxybenzone (BP-3), triclocarban (TCC), chlorfenapyr (CPP), flufenoxuron (FFN), hexythiazox (HTZ), octocrylene (OCR), padimate-O (PADO), 2-ethylhexyl salicylate (EHS), and homosalate (HMS). All extractions were performed in triplicate. In addition to FIGS. 29A-C for the PIL 2a sorbent, the peak area's relative standard deviation (RSD) for all analytes obtained from triplicate extractions ranged from 6.21% to 17.42%. Likewise, for the PIL 2b sorbent, the values ranged between 3.73% to 17.35%, while for the PIL 2c sorbent, they ranged between 5.83% and 15.75%. To evaluate fibers obtained from different wells but printed simultaneously, the PIL 2a, 2d, and 2e sorbents were compared. The PIL 2d sorbent produced RSDs ranging from 3.41% to 11.63%, whereas values ranged from 5.13 to 17.91% for the PIL 2e sorbent. Finally, to assess printed sorbents from different batches, sorbents PIL 2a, 2f, and 2g were compared. The peak areas of all extracted analytes from PIL 2f produced RSDs ranging from 4.67% to 12.92%, while the PIL 2g sorbent had values ranging from 4.70 to 12.17%, indicating a very similar extraction performance.

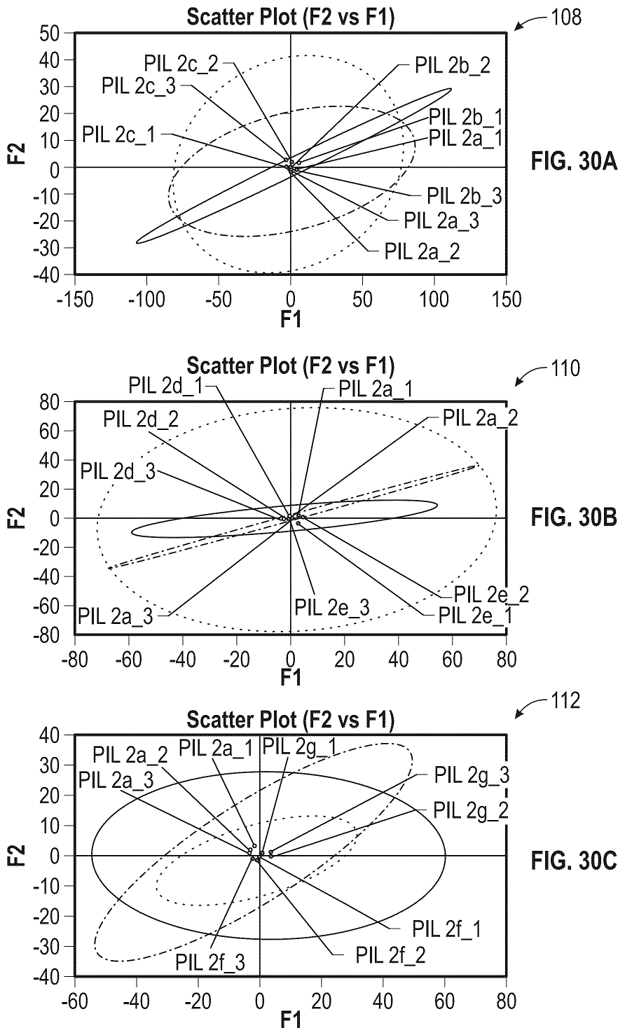

To evaluate inter-sorbent precision, the extraction data was analyzed using principal component analysis (PCA). PCA simplifies the complexity of multivariable datasets, in this case, the peak areas of the extracted analytes, while retaining critical information. Score plots constructed using the two most important principal components, PC1 and PC2, are shown in FIGS. 30A-C. A comparison of the PIL 2a, 2b, and 2c sorbents produced a combined variance of 88.02% for PC1 and PC2 as shown in FIG. 30A. A comparison of PIL 2a, 2d, and 2e yielded a combined variance of 80.02% as shown in FIG. 30B, while the PIL 2a, 2f, and 2g sorbents produced a value of 88.02% as shown in FIG. 30C. Ellipses representing a 95% confidence interval exhibited significant overlap, indicating no statistical difference in the extracted data using the printed fibers. Comparison of sorbent-to-sorbent extraction data using principal component analysis (PCA) of ten analytes extracted by 3D printed fiber sorbents. All sorbents were composed of 85% (w/w) [OVIM][Br] IL, 12% (w/w) DUDMA, and 3% (w/w) TPO. Ellipses are drawn to indicate 95% confidence intervals, with triplicate extractions being performed for each sorbent. As shown by numeral 108, examined sorbents include PIL 2a (blue), PIL 2b (green), and PIL 2c (purple) obtained from the same printing well and printed at the same time. As shown by the numeral 110, PIL 2a (blue), PIL 2d (green), and PIL 2e (purple) were obtained from the different printing well and printed at the same time. In addition, as shown by numeral 112, PIL 2a (blue), PIL 2f (green), and PIL 2g (purple) were obtained from the different printing well and printed at different times. Experimental conditions: Concentration of analytes is 500 μg L^{-1;} Sample volume is 15 mL; Stirring rate is 1000 rpm; Extraction time is 60 minutes; Extraction temperature is 22° C.; Static desorption volume is 100 uL; Desorption solvent is ACN; Desorption time is fifteen minutes; and Desorption temperature is 22° C. The ten analytes include: bisphenol A (BPA), oxybenzone (BP-3), triclocarban (TCC), chlorfenapyr (CPP), flufenoxuron (FFN), hexythiazox (HTZ), octocrylene (OCR), padimate-O (PADO), 2-ethylhexyl salicylate (EHS), and homosalate (HMS).

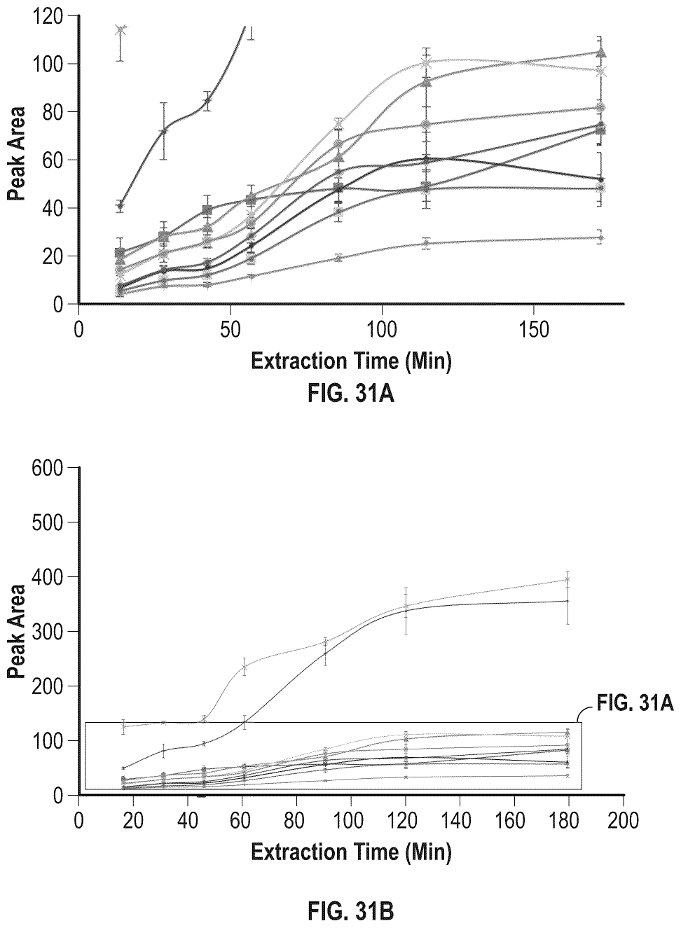

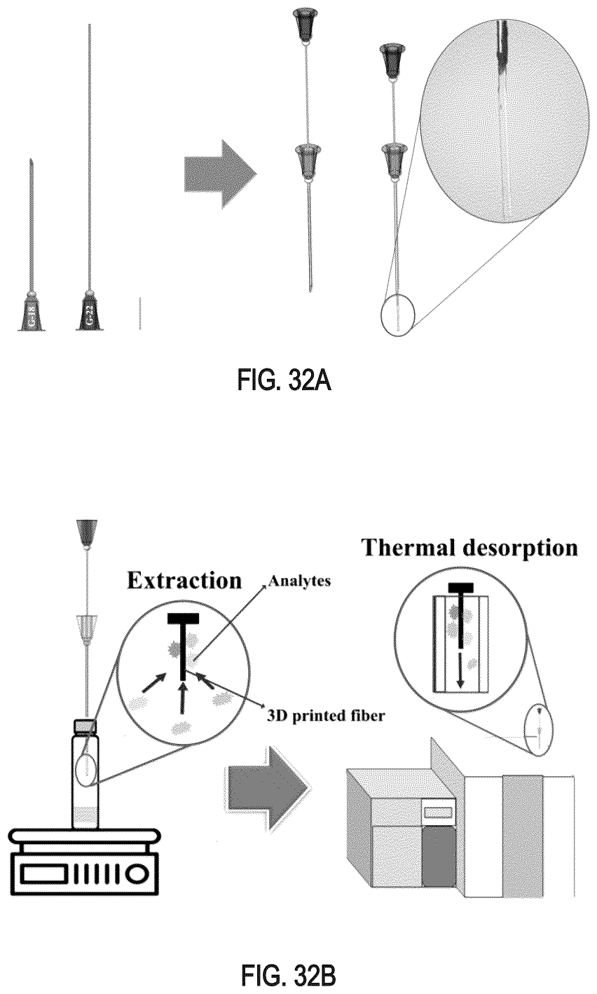

The extraction time is an important parameter that requires careful consideration in non-exhaustive extraction techniques such as SPME. To demonstrate the extraction capabilities of the 3D-printed PIL fibers, a diverse range of analytes with log P values ranging from 2.2 to 6.16 (Table 4) were selected. A printed fiber sorbent was used to generate a sorption-time profile featuring extraction times up to 180 minutes, as shown in FIGS. 31A-B and as indicated by reference numerals 3101-3110. Sorption-time profiles were obtained using the PIL 2d sorbent. The ten analytes include bisphenol A (3101 (dark blue)), oxybenzone (3102 (dark red)), triclocarban (3103 (dark tan)), chlorfenapyr (3104 (yellow)), flufenoxuron (3105 (light blue)), hexythiazox (3106 (light green)), octocrylene (3107 (dark blue)), padimate-O (3108(brown)), 2-ethylhexyl salicylate (3109 (dark green)), and homosalate (3110 (purple)). Extraction conditions included the concentration of analytes being 500 μg L⁻¹; Sample volume is 15 mL; Stirring rate is 1000 rpm; Extraction temperature is 22° C.; and Static desorption volume is 100 microliters. Static desorption conditions involved ACN as a desorption solvent; Desorption time is fifteen minutes; and a desorption temperature of 22° C. All extractions were performed in triplicate.

The majority of analytes, including CFP, FFN, HTZ, OCR, PADO, and HMS, were found to reach equilibrium at an extraction time of 120 minutes. In contrast, analytes, including BPA, BP-3, TCC, and EHS, produced higher peak areas at an extraction time of 180 minutes. In the case of PADO, for example, the peak area was found to increase by 23.7% from 90 to 120 minutes but increased by only 5.2% when extending the extraction time by another hour. Therefore, an optimal extraction time of 120 minutes was used.

A method using the printed fiber sorbents for analyte extraction followed by HPLC analysis was validated in terms of linearity, LODs, and LOQs. Adequate linearity was found with R² values varying from 0.926 to 0.993 for all analytes, along with acceptable standard errors for the slope and Y-intercept. LODs varied from 0.13 to 45 μg L⁻¹, and the LOQs ranged from 0.43 to 150 μg L⁻¹. PADO was found to have the lowest LOQ, while BPA produced the highest value among the analytes tested. Since the fabrication method, prepolymer composition, and the PIL coating layer are all markedly different from previous PIL extraction studies, and the 3D printed PIL sorbents were observed to offer comparable performance in detecting analytes at trace levels compared to previous studies using PIL-based SPME sorbents coupled to HPLC.

### EXAMPLE 11

### Examination of the Lifetimes of the Extraction Devices

Using the newly developed fabrication method for producing PIL sorbents, the lifetimes of the extraction devices were examined by performing twenty extraction/desorption steps and monitoring the extraction performance of the sorbents. Additionally, the repeatability of extraction efficiency for the printed PIL fibers was investigated due to the fact that losses in extraction efficiency can occur when PILs are desorbed using organic solvent. Three fibers (PIL 2a, 2b, and 2c) were used to perform triplicate extractions prior to and after twenty extractions. As shown in FIGS. 29A-C, the peak areas of all analytes were compared for the first three extractions and for the 21^{st}, 22^{nd}, and 23^{rd} extractions using the same sorbent at an extraction time of sixty minutes. A Student's t-test was performed on all extracted analytes, and probability values (p-values) were used to assess whether a significant difference in extraction efficiencies occurred between the two datasets, with a significance level of 0.05. As listed in Table 7 below, the p-values of all extracted analytes revealed no significant difference in extraction efficiencies between the two datasets. For PIL 2a, the obtained p-values were larger than 0.05, indicating that no significant difference was found in comparing the average response of the analytes in the first three extractions and the average of 21^{st}, 22^{nd}, and 23^{rd} extractions.

TABLE 7

| | p-value | | |
|---|---|---|---|
| Analyte | PIL 2a | PIL 2b | PIL 2c |
| BPA | 0.103 | 0.065 | 0.237 |
| BP-3 | 0.258 | 0.112 | 0.345 |
| TCC | 0.863 | 0.023 | 0.002 |
| CFP | 0.956 | 0.045 | 0.025 |
| FFN | 0.593 | 0.061 | 0.066 |
| HTZ | 0.227 | 0.004 | 0.236 |
| OCR | 0.456 | 0.716 | 0.420 |
| PADO | 0.385 | 0.651 | 0.549 |
| EHS | 0.873 | 0.482 | 0.118 |
| HMS | 0.355 | 0.357 | 0.362 |

For Table 7 above, the probability values of all analytes by performing a student's t-test comparison between the average peak area between the first three extractions and the 21^{st}, 22^{nd}, and 23^{rd} extractions using the PIL 2a, PIL 2b, and PIL 2c fiber sorbents. Experimental conditions: Concentration of analytes is 500 g L⁻¹; Sample volume is 15 milliliters; Stirring rate is 1000 rpm; Extraction time is 60 minutes; Extraction temperature is 22° C.; Static desorption volume is 100 microliters; Desorption solvent is ACN; Desorption time is fifteen minutes; and the Desorption temperature is 22° C. The ten analytes include: bisphenol A (BPA), oxybenzone (BP-3), triclocarban (TCC), chlorfenapyr (CPP), flufenoxuron (FFN), hexythiazox (HTZ), octocrylene (OCR), padimate-O (PADO), 2-ethylhexyl salicylate (EHS), and homosalate (HMS).

Similarly, for the PIL 2b and 2c sorbents, no significant difference was found for most of the analytes, except for TCC, CFP, and HTZ, which exhibited p-values lower than 0.05. Nevertheless, when comparing the average of peak areas obtained from triplicate extractions with PIL 2b, the decrements in peak areas for TCC, CFP, and HTZ, were shown to be only 135%, 16%, and 6%, respectively. Likewise, for PIL 2c, the peak areas exhibited decreased by 12% and 23% for TCC and CFP, respectively. For the collected extraction data, the 3D-printed extraction devices demonstrated exceptional repeatability in extraction efficiency.

In summary, the extraction/desorption performance of 3D printed PIL sorbents was assessed to explore the potential of producing PIL extraction devices in batch scales using a low-cost modification to a desktop LCD 3D printer. The modification significantly reduced the printing volume of prepolymer mixtures from several hundreds of milliliters to just a few milliliters. The miniaturized printing platform can be used to develop novel photocurable printing materials without requiring large amounts of testing material. Due to the high customizability of 3D printing, it can be used to facilitate better control over the composition, thickness of printed layers, and geometries to ultimately produce devices with enhanced extraction performance.

### EXAMPLE 1

### Producing 3D Printed Fibers for Microextraction Studies Coupled to Gas Chromatography/Mass Spectrometry

The first step in the synthesis of the [HVIM][Br] IL monomer involved reacting 20 mmol of 1-vinylimidazole and 24 mmol of 1-bromohexane in a round bottom flask containing 10 milliliters of 2-propanol at 60° C. for sixty hours under a nitrogen atmosphere. The reaction mixture was then cooled to room temperature, and 2-propanol was removed under vacuum. The crude product was dissolved in water and purification was achieved by washing three times with ten-milliliter aliquots of ethyl acetate. Purified [HVIM][Br] IL was recovered by removing water under vacuum at 50° C. Synthesis of the [HVIM][NTf2] IL monomer involved a metathesis reaction consisting of 10 mmol of [HVIM][Br] and 13 mmol of LiNTf2 in a 250-milliliter round bottom flask. The reaction was stirred at room temperature for twenty-four hours. After decanting the upper water layer, an oily IL monomer layer appeared. The crude IL layer was then dissolved in dichloromethane and washed five times with twenty milliliters of water. The final aqueous layer was tested with silver nitrate to ensure no silver chloride precipitation was formed. The purified [HVIM][NTf₂] IL was then collected, and the solvent was removed under vacuum. The synthesized monomer was covered with aluminum foil to protect it from light and dried overnight in a vacuum oven. A yellow liquid was obtained as the final product.

The second step involved the preparation of a prepolymer mixture for 3D printing. The prepolymer mixture in this illustration included the prepolymer monomer (IL monomer) [HVIM][NTf₂], DUDMA crosslinker, and TPO photoinitiator. The final composition of the mixture was 85% monomer (w/w), 12% crosslinker (w/w) and 3% photoinitiator (w/w) dissolved in methanol. The digital files of the twelve cylinders representing fiber-type sorbent were sent to a software slicer, e.g., Photon® Workshop, to set up the printing parameters for printing with the LCD 3D printer, e.g., Photon Mono® 4K LCD 3D printer.

The printing parameters included a layer exposure time of seven seconds, a bottom exposure time of thirty seconds, and a z-axis lifting time of 0.5 seconds. Approximately four milliliters were used for the six well cell plate functioning as a printing platform. After the printing process was completed, the sorbents were placed in methanol:water (80:20, v/v) for two minutes to remove any uncured residual resin. Post-curing of the sorbents was carried out in an Anycubic® Cure station using a UV wavelength of 405 nanometers for ten minutes at room temperature.

The extraction device containing the 3D printed PIL SPME fiber was assembled into a device. A SPME device was designed and constructed to enable the extraction and desorption using the 3D printed sorbents. The 3D printed PIL SPME fiber was attached to a 22-gauge needle (4 inches in length) using steel JB Weld glue. The fiber and needle assembly were then inserted into an 18-gauge needle (2 inches in length). The area between the two needles was filled with PDMS to prevent gas leakage when the SPME device was inserted into the GC inlet. The device was then placed in a desiccator for 24 hours to allow the glue to solidify.

To evaluate the performance and compatibility of the [HVIM][NTf₂] fibers as an extraction sorbent following GC desorption, headspace extractions were performed using a 3D-printed PIL SPME device to extract eleven analytes (β-Pinene, γ-Terpinene, Mequinol, Linalool, Isoborneol, Menthol, Terpinen-4-ol, Geraniol, Thymol, Eugenol, and Nerolidol). After extraction, thermal desorption was carried out in the GC inlet.

FIGS. 3 A and 32B describe images of the 3D printed fibers and SPME device as well as the workflow for extraction/desorption of analytes from the fibers into the inlet of a GC/MS instrument. The analyses were performed on a 7890B GC system equipped with a 5977A MS detector (single quadrupole) from Agilent Technologies (Santa Clara, CA, USA). Separation of the analytes was achieved using an Rtx-5 ms capillary column (30 m×0.25 mm I.D.×25 um film thickness) from Restek (Bellefonte, PA, USA). Ultrapure helium served as the carrier gas at a flow rate of 1 mL/min. The inlet operated in split mode with a split ratio of 50:1 and was maintained at 250° C. The oven temperature program was as follows: an initial temperature of 80° C. held for 1 minute, followed by an increase of 5° C./min to 130° C., then 15° C./min to 150° C., and finally 20° C./min to 300° C., where it was held for 3 minutes. The ion source and transfer line temperatures were set at 230° C. and 280° C., respectively. The MS operated in electron ionization (EI) mode at 70 eV, with the quadrupole temperature held at 150° C.

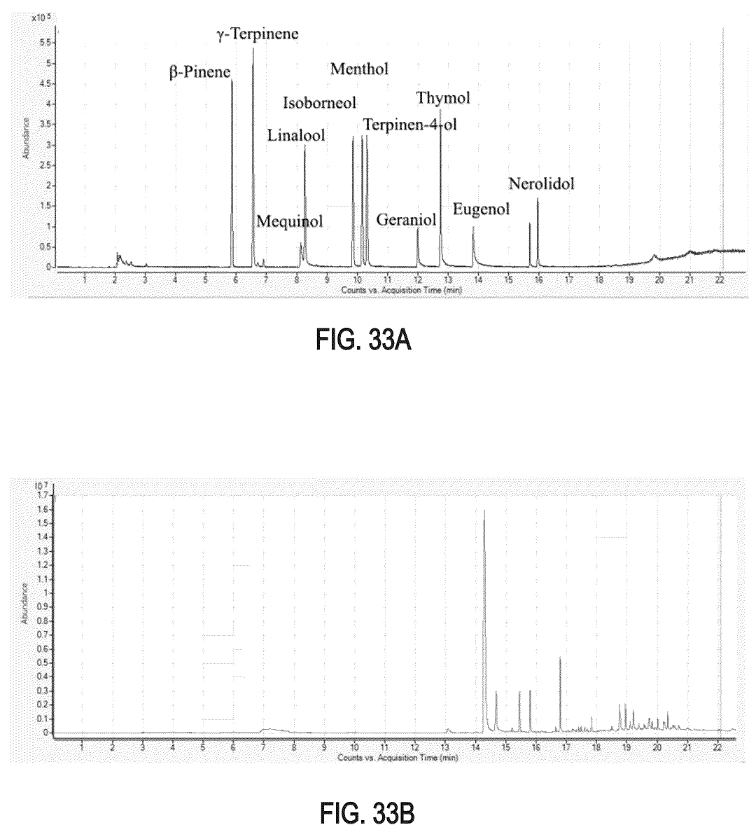

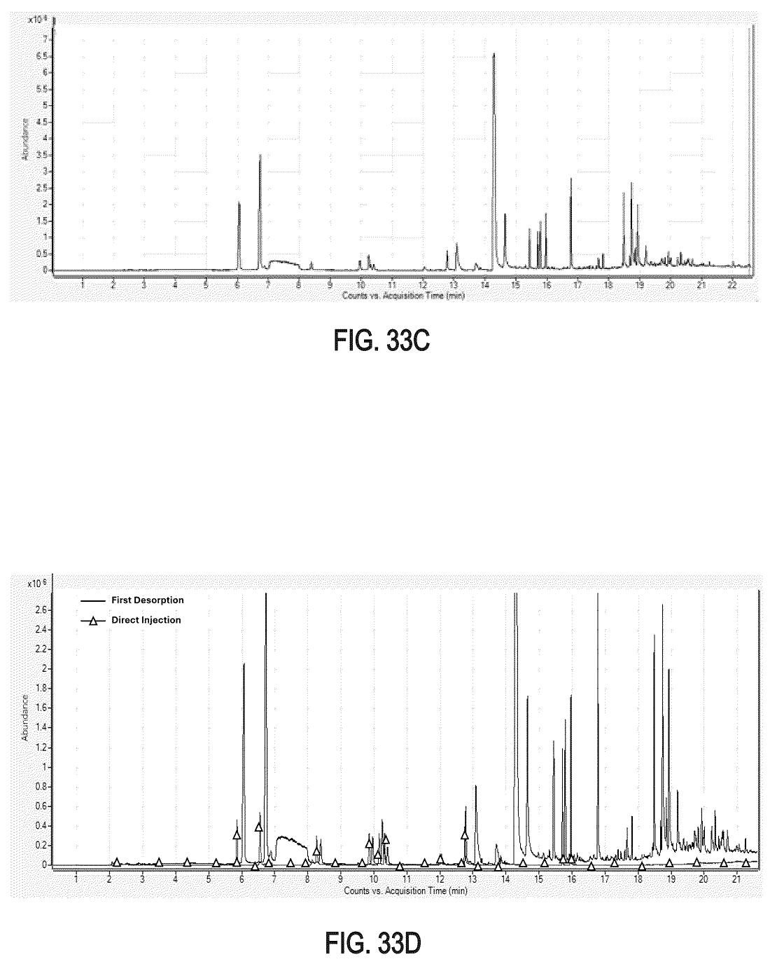

Direct injection of standards into the GC-MS were performed by injecting 1 microliter of a mixture containing the eleven analytes, each at a concentration of 50 milligram/liter in methanol. The resulting chromatogram from the direct injection is shown in FIG. 33A. Before extraction, the printed fiber underwent an initial conditioning process. The SPME device was inserted into the GC inlet at 250° C. for 3 minutes, with this conditioning step repeated three times. A fiber blank was analyzed by exposing the fiber to the GC inlet for 2 minutes, followed by a GC run to establish the baseline chromatogram. This fiber blank chromatogram is shown in FIG. 33B.

For the extraction procedure, 4 milliliters of water spiked with the analytes at a concentration of 5 milligram/liter was placed in a 20 milliliters headspace vial and stirred for five minutes before extraction. Each extraction was performed at 50° C. with the fiber inserted into the headspace for 10 minutes while the solution stirred at 600 rpm. After extraction, the fiber was thermally desorbed in the GC injector for 2 minutes at 250° C. in split mode (50:1). eChromatograms from the first desorption are shown in FIG. 33C. FIG. 33D shows the chromatographs of the direct injection and the first desorption following an extraction overlayed.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

List of Reference Characters

| | |
|---|---|
| 10 | 3D printer with liquid crystal display (LCD) |
| 11 | Printed build plate with black polylactic acid filament |
| 12 | Build plate |
| 14 | Material tank |
| 16 | 3D printing material such as prepolymers, e.g., a mixture |
| | of monomer, crosslinker, photoinitiator, and so forth |
| 18 | Light source |
| 20 | Commercial build plate |
| 22 | Commercial material tank |
| 24 | Six-hole build plate |
| 26 | Six well cell plate functioning as a material tank |
| 28 | Twenty-four hole build plate |
| 30 | Twenty-four hole cell plate functioning as a material tank |
| 32 | 5/16″ -18 screw |
| 34 | Hex nut(s) |
| 36 | Round disk magnet(s) |
| 38 | Locking washer |
| 40 | Flat head screw |
| 41 | Length (L) of blade |
| 42 | Cuboids representing blade-type sorbents |
| 43 | Width (W) of blade |
| 44 | Cylinders |
| 45 | Height (H) of blade |
| 46 | Scanning electron micrographs (SEM) showing the 3D-printed |
| | blade |
| 47 | Diameter of fiber |
| 48 | Scanning electron micrographs (SEM) showing the fiber PIL |
| 49 | Length of fiber (L) |
| 50 | Scanning electron micrographs (SEM) showing fiber sorbent 50 |
| 52 | Assembly of extraction device with 3D printed PIL sorbent |
| 54 | Epoxy glue |
| 56 | Blunt tip syringe needle, e.g., 18 G. |
| 58 | Prepared 3D-printed PIL sorbent |
| 60 | Blade sorbent half-immersed in ACN |
| 62 | Blade sorbent half-immersed in MeOH |
| 64 | Fiber sorbent fully immersed in ACN |
| 66 | Fiber sorbent fully immersed in MeOH |
| 68 | Small scale printing |
| 70 | Blade sorbent |
| 72 | Simultaneous printing with different prepolymer mixtures |
| 74 | Printing with 0% (w/w) of [OVIM][Br], 47% (w/w) DUDMA, |
| | and 3% (w/w) TPO |
| 76 | Printing with 85% (w/w) of [OVIM][Br], 12% (w/w) DUDMA, |
| | and 3% (w/w) TPO |
| 80 | Versatility of fabricating both blade and fiber PIL sorbents |
| 82 | Blade sorbent |
| 84 | Fiber PIL sorbent |
| 90 | Sequential steps undertaken for the fabrication of 3D printed PIL |
| | sorbent |
| 92 | 3D Printing of PIL sorbents |
| 94 | Sorbent fabricated into extraction device |
| 96 | Sorbent conditioning |
| 98 | Extraction/Desorption |
| 100 | HPLC separation |
| 102 | HPLC analysis of Fibers PIL 2a, PIL 2b, and PIL 2c were |
| | obtained from the same printing well and printed at the |
| | same time |
| 104 | HPCL analysis of Fibers PIL 2a, PIL 2b, and PIL 2c were |
| | obtained from the same printing well and printed at the |
| | same time |
| 106 | HPLC analysis of Fibers PIL 2a, PIL 2f, and PIL 2g were |
| | obtained from different printing wells and printed at |
| | different times. |
| 108 | Examined sorbents include PIL 2a (blue), PIL 2b (green), |
| | and PIL 2c (purple) obtained from the same printing well |
| | and printed at the same time |
| 110 | PIL 2a (blue), PIL 2d (green), and PIL 2e (purple) were |
| | obtained from the different printing well and printed at |
| | the same time |
| 112 | PIL 2a (blue), PIL 2f (green), and PIL 2g (purple) were |
| | obtained from the different printing well and printed at |
| | different times |

From the foregoing, it can be seen that the present disclosure accomplishes at least all of the stated objectives.

The inventions being thus described, it will be obvious that the same may be varied in many ways. Such variations are not to be regarded as a departure from the spirit and scope of the inventions and all such modifications are intended to be included within the scope of the following claims.

The above specification provides a description of a system, a polymeric ionic liquid (PIL) sorbent, and a method, all of which includes various polymeric ionic liquid (PIL) sorbent printed by a 3D printer. Since many embodiments can be made without departing from the spirit and scope of the present disclosure, the invention resides in the claims.

The scope of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A system for 3D printed polymeric ionic liquid (PIL) extraction sorbents comprising of:
a photocuring 3D printer utilizing a build plate having a plurality of holes and a resin tank formed of a plurality of individual wells with a prepolymer monomer blended with a crosslinker and a photoinitiator is placed in the plurality of wells to form a plurality of 3D printed PIL sorbents on the build plate;
a fabrication device that prepares the polymeric ionic liquid (PIL) for extraction;
at least one container for conditioning, extracting, and desorption of the polymeric ionic liquid (PIL); and
an analytical instrument to provide separation resulting in a batch production of PIL sorbents.

2. The system of claim 1, wherein the buildplate having a plurality of holes is 3D printed and the resin tank formed of a plurality of individual wells.

3. The system of claim 2, wherein the resin tank formed of a plurality of individual wells are each coated with an elastomer.

4. The system of claim 1, wherein the extraction device includes a projectile and an adhesive.

5. The system of claim 1, wherein the 3D printed sorbent is in the form of either a blade sorbent or fiber sorbent.

6. The system of claim 5, wherein the container includes either ACN or MeOH for at least partial immersion and conditioning of either the blade sorbent or the fiber sorbent.

7. A method of creating 3D printed polymeric ionic liquid (PIL) extraction sorbents comprising:
placing a prepolymer monomer and/or a crosslinker, with a photoinitiator into a customized resin tank formed of a plurality of individual wells;
utilizing a photocuring 3D printer having a buildplate with a plurality of holes and the customized resin tank formed of a plurality of individual wells; and
printing PIL extraction sorbents in the form of a blade or a cylindrical fiber.

8. The method of claim 7, wherein at least one prepolymer monomer selected from the group consisting of [OVIM][Br] or [OVIM][NTf₂], the crosslinker includes DUDMA and the photoinitiator includes TPO.

9. The method of claim 7, further comprising the step of removing uncured residual resin after the printing of the PIL sorbents.

10. The method of claim 9, further comprising the step of post-curing through applying UV light to the PIL sorbents after removing uncured residual resin after the printing of the PIL sorbents.

11. The polymeric ionic liquid (PIL) sorbent of claim 7, wherein the sorbent is the blade and the blade has a length of from about 0.1 mm to about 1 mm, a width of from about 0.5 mm to about 1 mm, and a height of from about 0.1 mm to about 1 mm.

12. The polymeric ionic liquid (PIL) sorbent of claim 7, wherein the sorbent is the cylindrical fiber and the fiber has a diameter of from about 0.6 mm to about 1 mm, and a length of from about 0.1 mm to about 1 mm.

13. The polymeric ionic liquid (PIL) sorbent of claim 7, wherein the extraction sorbents includes both blades and fibers.

14. A method of analyte extraction comprising:
contacting the polymeric ionic liquid (PIL) sorbent created by the method of claim 7 with a sample, wherein the sample comprises an analyte; and wherein the analyte is a solid and is adsorbed, or a liquid and is absorbed.

15. The method of claim 13, further comprising the step of conditioning the polymeric ionic liquid (PIL) sorbent prior to the contacting step.

16. The method of claim 15, further comprising a step of desorbing the analyte from the eutectic extraction sorbent.

17. The method of claim 16, further comprising testing the analyte with an analytical instrument.

18. The method of claim 17, wherein the analytical instrument is a high performance liquid chromatography instrument (“HPLC”), an ultra-performance liquid chromatography instrument (“UPLC”), a next generation chromatograph (“NGC”), a mass spectrometer (“MS”), a gas chromatograph (“GC”), a colorimeter, a mass spectrometer, a fluorometer, a photometer, a spectrometer, a spectrophotometer, a X-ray photoelectron spectrometer (“XPS”), or a combination thereof.

19. The method of claim 18, wherein the testing comprises quantifying the analyte.
